(19) United States
(12) Patent Application Publication
(10) Pub. No.: US 2015/0120577 A1
(43) Pub. Date: Apr. 30, 2015

(54) SYSTEMS AND METHODS FOR ENTERPRISE MANAGEMENT USING CONTEXTUAL GRAPHS

(71) Applicant: Clique Intelligence, Redwood City, CA (US)

(72) Inventors: Sanjay Lobo, Pottsboro, TX (US); Art Leondires, Redwood City, CA (US); Alan MacLeod, Redwood City, CA (US); Neil Okamoto, Glendale, CA (US); Ed Hicks, Brooklyn, NY (US)

(21) Appl. No.: 14/506,524

(22) Filed: Oct. 3, 2014

Related U.S. Application Data
(60) Provisional application No. 61/887,283, filed on Oct. 4, 2013.

(51) Int. Cl. G06Q 10/10; H04L 29/06

(52) U.S. Cl. CPC G06Q 10/103; H04L 63/08
USPC 705/301

(57) ABSTRACT

The disclosed technology provides a unified collaborative tool and workspace to access people, content, and tools within the context of completing a project or task. The system streamlines the way that projects or tasks get done, while providing a system of record for the project or task that is neatly and intuitively organized within the context of that project or task. The collaborative workspace with context is customized for each user at an enterprise. Portions of the collaborative workspace accessible to a given user are shared with a designated set of other users, allowing all users with access to contribute and share information, documents, and resources within a particular context, such as a particular project or task.

### RELATED APPLICATIONS

The present application claims priority to and the benefit of U.S. Provisional Application No. 61/887,283, titled “Systems and Methods for Enterprise Management Using Contextual Graphs”, filed Oct. 4, 2013, the content of which is hereby incorporated by reference in its entirety.

### BACKGROUND OF THE INVENTION

A wide variety of collaboration and communication tools are used by enterprises on a daily basis. These tools are largely fragmented within a given enterprise in that enterprise users of such tools are still left to manually associate these tools with people, places, and things within the context of a particular collaborative effort. For example, at the beginning of a project, a team of individuals is identified, and a wide variety of actions are taken by the individuals using such tools in a largely fragmented way. Documents, for example, are manually loaded into different web workspaces. Questions are asked over email. Conference calls are scheduled in calendaring applications and executed via speakerphones and video solutions.

There is a benefit in improving the effectiveness of conventional business workflows and collaboration tools to enhance the accessing and sharing of skills and knowledge within an enterprise organization and reducing information clutter inherent in such complex work environments.

### SUMMARY OF THE INVENTION

The disclosed technology provides a unified collaborative tool and workspace to access people, content, and tools within the context of completing a project or task. To this end, the system streamlines the way that projects or tasks get done, while providing a system of record for the project or task that is neatly and intuitively organized within the context of that project or task.

In certain embodiments, the collaborative workspace with context (herein referred to as a collection of contextual collaborations) is customized for each user at an enterprise. The collaborative workspaces (namely, an individual contextual collaboration) accessible to a given user are shared with a designated set of other users, allowing all users with access to contribute and share information, documents, and resources within a particular context, such as a particular project or task. The set of users with access may be limited to users within the same organization/business domains as the given user, or, alternatively, they may also include users external to such organization/domains.

In being centered around the context of completing a project or task, the collaborative workspace (namely, the collection of contextual collaborations) illuminates and brings forward information that is most relevant to the project or tasks at any given moment. A contextual collaboration may be employed in connection with, for example, but not limited to, the production, approval, and archival of documents (and/or files) and with the logistics of planning, sharing, and documenting enterprise-based resources for events and meetings.

In one aspect, the present disclosure describes a method for creating a collection of contextual collaborations for users associated with an enterprise in which each contextual collaboration groups users, permissions, and one or more members selected from the group consisting of files, priorities, tasks, statuses, and assets, in a single unified collaborative access and presentation space. The method comprises creating, by a processor of a computing device (e.g., a server), for each of a plurality of users associated with the enterprise (e.g., employees of the enterprise, guests of the enterprise, administrators of the enterprise, etc.), a context list of a plurality of contextual collaborations specific to the user.

The step of creating the context lists comprises for each of the plurality of contextual collaborations: assigning to the contextual collaboration a set of resources (e.g., files and assets) associated with the contextual collaboration (e.g., wherein the assigning allows nesting of contextual collaborations within other collaborations), the set of resources having been received from one or more of the plurality of users; assigning to the contextual collaboration one or more tasks, wherein each task is associated with (i) the contextual collaboration or (ii) a resource of the collaboration (e.g., wherein each task comprises an associated originator of the task, a due date, and a task completion status) (e.g., wherein each of the one or more tasks has been received from one of the plurality of users); determining a set of users associated with the contextual collaboration to whom a graphical representation of the contextual collaboration will be made visually available transmitting, via a network, for each of the plurality of users, data representing content of a newly created or updated context list corresponding to the user; and causing the data to be graphically rendered, on a display of a computing device associated with a given user (e.g., a registered user), wherein the context list is graphically rendered (i) such that the contextual collaborations populating the context list are positioned on the display in an order reflecting a priority status or time, the priority status or time being associated with each contextual collaboration (e.g., graphically positioned top-to-bottom in sequential order according to time of creation, time of last update, time of expiration of the contextual collaboration, assigned priority value associated with the contextual collaboration, assigned priority value associated with a resource within the collaboration) and (ii) such that each of the contextual collaborations of the context list graphically indicates one or more of the following associated therewith: files, users, priorities, tasks, statuses, and assets.

In some implementations, each contextual collaboration within the context list graphically presents (a) the set of resources (e.g., group of files and assets) associated with a given contextual collaboration and (b) the one or more tasks associated with the given contextual collaboration (e.g., completed statuses) in a list within a first subset of an area reserved for the given collaboration, such that, collectively, the first subset associated with a plurality of presented collaboration are graphically aligned in the presentation space.

In some implementations, each contextual collaboration within the context list graphically presents (a) the set of users associated with a given contextual collaboration and (b) comments from the set of users in connection with the given contextual collaboration, in a list within a second subset of an area reserved for the given collaboration, such that, collectively, the second subset associated with a plurality of presented collaboration are graphically aligned in the presentation space.

In some implementations, each contextual collaboration within the context list presents (a) the collaboration name, (b) the expiration date, and (c) the priority value, associated with a given contextual collaboration, in a third subset of an area reserved for the given collaboration, such that, collectively, the third subset associated with a plurality of presented collaboration are graphically aligned in the presentation space.

In some implementations, the method further includes, for each of the contextual collaborations, updating, by the processor, the set of resources associated with the contextual collaboration following a change in the set of resources associated with the contextual collaboration; for each of the context lists, updating the context list by eliminating any archived contextual collaboration (and/or concealing or not displaying contextual collaborations that have aged beyond a predetermined time, or limiting the number of displayed contextual collaborations to a given number or data size, or limiting initial display of contextual collaborations to a given number or data size of contextual collaborations while revealing older contextual collaborations upon further scroll-down or other user feedback), and adding new contextual collaborations associated with the user or previously-created contextual collaborations that are newly associated with the user, and graphically rendering, on the display of the corresponding registered user's computing device, the updated context list; and for each of the context lists, locking any expired contextual collaborations such that the contextual collaboration and set of resources associated with the contextual collaboration are viewable, but not modifiable, to the plurality of users (e.g., and are not viewable to guests).

In some implementations, the method further includes creating, by a processor of a computing device (e.g., a server), upon input by a user, a new contextual collaboration by: assigning to the new contextual collaboration a set of resources associated with the contextual collaboration; determining a set of users associated with the new contextual collaboration to whom a graphical representation of the contextual collaboration will be made visually available; and changing, by a processor of a computing device (e.g., a server), upon input by a user, one or more of: the set of resources associated with a given contextual collaboration; and the set of users associated with the given contextual collaboration.

In some implementations, each of the contextual collaborations has an associated set of permissions governing addition and/or removal of one or more of the following: users, files, and resources associated with the contextual collaboration, the set of permissions comprising: a first permission setting to allow or prevent the plurality of users associated with the contextual collaboration from adding guests to the contextual collaboration.

In some implementations, the set of permissions further comprises: a second permission setting to allow or prevent downloading of files associated with the contextual collaboration by the plurality of users associated with the contextual collaboration.

In some implementations, the set of permissions further comprises: a third permission setting to allow or prevent one or more of the plurality of users associated with the contextual collaboration to set the priority value for the contextual collaboration.

In some implementations, each contextual collaboration comprises a tag icon selectable to display a list of tags associated with the contextual collaboration, the tag icon being located in a fourth subset of an area reserved for the given collaboration, such that, collectively, the fourth subset associated with a plurality of presented collaboration are graphically aligned in the presentation space.

In some implementations, the tag icon is selectable between an expanded state and a collapsed state, and wherein the expanded state displays all tags associated with the contextual collaboration and/or all tags associated with a given file or resource embedded within the contextual collaboration.

In some implementations, the method further comprises: creating a contextual collaboration from an email, said email having an addressor, one or more addressee, an email body, an email subject, and one or more attachments. The creating step may include assigning, via the processor, the addressor and the one or more addressee(s) as the plurality of users for a new collaboration; assigning, via the processor, the email subject as a name of the new collaboration; assigning, via the processor, the email body as a comment within the collaboration; and assigning, via the processor, the one or more attachments as files of the collaboration.

In some implementations, the method further comprises: assigning to the contextual collaboration a document approval status associated with one or more documents of the contextual collaboration, wherein the document approval status is associated with a document approval request having been sent to one or more users of the plurality of users, the document approval request having been responded to by the one or more users, wherein the response is selected from an approved status and a not-approved status.

In some implementations, the not-approved status is accompanied by one or more comments associated with a reason for the non-approval of the document.

In another aspect, the present disclosure describes a system for creating a collection of contextual collaborations for users associated with an enterprise in which each contextual collaboration groups users, permissions, and one or more members selected from the group consisting of files, priorities, tasks, statuses, and assets, in a single unified collaborative access and presentation space. The system includes a processor and a memory having instructions thereon, wherein the instructions when executed by the processor, cause the processor to create, for each of a plurality of users associated with the enterprise (e.g., employees of the enterprise, guests of the enterprise, administrators of the enterprise, etc.), a context list of a plurality of contextual collaborations specific to the user.

The step of creating the context lists, of the instructions, comprises, for each of the plurality of contextual collaborations: assigning to the contextual collaboration a set of resources (e.g., files and assets) associated with the contextual collaboration (e.g., wherein the assigning allows nesting of contextual collaborations within other collaborations), the set of resources having been received from one or more of the plurality of users; assigning to the contextual collaboration one or more tasks, wherein each task is associated with (i) the contextual collaboration or (ii) a resource of the collaboration (e.g., wherein each task comprises an associated originator of the task, a due date, and a task completion status) (e.g., wherein each of the one or more tasks has been received from one of the plurality of users).

The instructions, when executed by the processor, further cause the processor to determine a set of users associated with the contextual collaboration to whom a graphical representation of the contextual collaboration will be made visually available. The instructions, when executed by the processor, further cause the processor to transmit, via a network, for each of the plurality of users, data representing content of a newly created or updated context list corresponding to the user.

The instructions, when executed by the processor, further cause the processor to cause the data to be graphically rendered, on a display of a computing device associated with a given user (e.g., a registered user), wherein the context list is graphically rendered (i) such that the contextual collaborations populating the context list are positioned on the display in an order reflecting a priority status or time, the priority status or time being associated with each contextual collaboration (e.g., graphically positioned top-to-bottom in sequential order according to time of creation, time of last update, time of expiration of the contextual collaboration, assigned priority value associated with the contextual collaboration, assigned priority value associated with a resource within the collaboration) and (ii) such that each of the contextual collaborations of the context list graphically indicates one or more of the following associated therewith: files, users, priorities, tasks, statuses, and assets.

In some implementations, each contextual collaboration within the context list graphically presents (a) the set of resources (e.g., group of files and assets) associated with a given contextual collaboration and (b) the one or more tasks associated with the given contextual collaboration (e.g., completed statuses) in a list within a first subset of an area reserved for the given collaboration, such that, collectively, the first subset associated with a plurality of presented collaboration(s) are graphically aligned in the presentation space.

In some implementations, each contextual collaboration within the context list graphically presents (a) the set of users associated with a given contextual collaboration and (b) comments from the set of users in connection with the given contextual collaboration, in a list within a second subset of an area reserved for the given collaboration, such that, collectively, the second subset associated with a plurality of presented collaboration(s) are graphically aligned in the presentation space.

In some implementations, each contextual collaboration within the context list presents (a) the collaboration name, (b) the expiration date, and (c) the priority value, associated with a given contextual collaboration, in a third subset of an area reserved for the given collaboration, such that, collectively, the third subset associated with a plurality of presented collaboration(s) are graphically aligned in the presentation space.

In some implementations, the instructions, when executed by the processor, further cause the processor to, for each of the contextual collaborations, update the set of resources associated with the contextual collaboration following a change in the set of resources associated with the contextual collaboration; for each of the context lists, update the context list by eliminating any archived contextual collaboration (and/or concealing or not displaying contextual collaborations that have aged beyond a predetermined time, or limiting the number of displayed contextual collaborations to a given number or data size, or limiting initial display of contextual collaborations to a given number or data size of contextual collaborations while revealing older contextual collaborations upon further scroll-down or other user feedback), and add new contextual collaborations associated with the user or previously-created contextual collaborations that are newly associated with the user, and graphically render, on the display of the corresponding registered user's computing device, the updated context list; and for each of the context lists, lock any expired contextual collaborations such that the contextual collaboration and set of resources associated with the contextual collaboration are viewable, but not modifiable, to the plurality of users (e.g., and are not viewable to guests).

In some implementations, the instructions, when executed by the processor, further cause the processor to create, upon input by a user, a new contextual collaboration by: assigning to the new contextual collaboration a set of resources associated with the contextual collaboration; determine a set of users associated with the new contextual collaboration to whom a graphical representation of the contextual collaboration will be made visually available; and change, upon input by a user, one or more of: the set of resources associated with a given contextual collaboration; and the set of users associated with the given contextual collaboration.

In some implementations, each of the contextual collaborations has an associated set of permissions governing addition and/or removal of one or more of the following: users, files, and resources associated with the contextual collaboration, the set of permissions comprising: a first permission setting to allow or prevent the plurality of users associated with the contextual collaboration from adding guests to the contextual collaboration.

In some implementations, the set of permissions further comprises: a second permission setting to allow or prevent downloading of files associated with the contextual collaboration by the plurality of users associated with the contextual collaboration.

In some implementations, the set of permissions further comprises: a third permission setting to allow or prevent one or more of the plurality of users associated with the contextual collaboration to set the priority value for the contextual collaboration.

In some implementations, each contextual collaboration comprises a tag icon selectable to display a list of tags associated with the contextual collaboration, the tag icon being located in a fourth subset of an area reserved for the given collaboration, such that, collectively, the fourth subset associated with a plurality of presented collaboration(s) are graphically aligned in the presentation space.

In some implementations, the tag icon is selectable between an expanded state and a collapsed state, and wherein the expanded state displays all tags associated with the contextual collaboration and/or all tags associated with a given file or resource embedded within the contextual collaboration.

In some implementations, the instructions, when executed by the processor, further cause the processor to create a contextual collaboration from an email, said email having an addressor, one or more addressee(s), an email body, an email subject, and one or more attachments. The creating step of the instructions includes assigning, via the processor, the addressor and the one or more addressee(s) as the plurality of users for a new collaboration; assigning, via the processor, the email subject as a name of the new collaboration; assigning, via the processor, the email body as a comment within the collaboration; and assigning, via the processor, the one or more attachments as files of the collaboration.

In some implementations, the instructions, when executed by the processor, further cause the processor to assign to the contextual collaboration a document approval status associated with one or more documents of the contextual collaboration, wherein the document approval status is associated with a document approval request having been sent to one or more users of the plurality of users, the document approval request having been responded to by the one or more users, wherein the response is selected from an approved status and a not-approved status.

In some implementations, the not-approved status is accompanied by one or more comments associated with a reason for the non-approval of the document.

It is an object of systems and methods described herein to explicitly model and store/manipulate enterprise resources in a data structure such that the orchestration of processes within the enterprise can be achieved efficiently and effectively, with minimal intervention of IT administrators.

To illustrate this concept, consider the situation in which an employee wants to schedule an ad-hoc meeting to present materials to colleagues about a new product the company is developing. The employee is reviewing a document (either authored by the author or by someone else) and wants to discuss this document with another employee(s). The system allows the employee to view the availability of these desired participants (e.g., other employee(s)) and have them added to the context.

In addition, the system acts as a security broker to allow access to users outside the domain of the employee. For example, the new product may be a top-secret project and thus the enterprise wants to have strict control over who can access the documents and how they access it. Yet, the presenter may want to share the presentation and the most recent product definition document with attendees before the meeting. Moreover, attendees of the meeting may be spread across different offices and may attend the meeting virtually. Currently, the presenter must schedule a room for the presentation, verify with the IT department that the necessary resources are in the meeting room, ask them to load the presentation onto a computer in the room, and set up a videoconference. Each of these tasks may involve a different enterprise resource and/or assistance from a third party such as an administrator. Additionally, the presenter will likely be required to share the confidential materials via email, a method that lacks the enterprise's desired security.

The systems and methods herein allow the presenter to orchestrate the event and associated resources effectively and efficiently, with no assistance of IT administrators, while satisfying the enterprise's security goals. Using the disclosed technology, the presenter creates a context, in this case, for example, the context represents the meeting. The presenter can associate the requested attendees of the meeting, presentation materials, the product definition document, the location of the live presentation, devices that the meeting will use (e.g., projectors or displays), the scheduled meeting time, as well as other resources with the context. The context will automatically be added to a context list for each of the requested attendees and the presenter. Each context list provides the associated individual with a timeline that allows them to view what contexts (and therefore what resources within those contexts) are involved in the activities they are working on. In this example, the context (e.g., the meeting) is added to each required attendees' context list. Each required attendee can view the context and the resources the presenter associated with the context.

The presenter can also grant certain permissions for the requested attendees. For example, some attendees may be allowed to add additional resources that they believe are relevant to the meeting and/or add additional individuals to the attendee lists. The presenter may limit the attendees to read-only access to the documents. Moreover, the system controls access to the documents and can prevent users from saving local copies depending on a particular enterprise's security protocol.

The system automatically loads the presentation materials onto the projector or display in the meeting room at the schedule time. Similarly, if employees are attending the meeting virtually, the documents can be pre-staged on that user's device prior to the scheduled meeting. Thus, the presenter can orchestrate the meeting within the enterprise efficiently and effectively, without the intervention of IT administrators.

The situation described above becomes more complex when different enterprises or domains share contexts. The contexts in the disclosed technology can involve resources (e.g., people or content) from more than one domain (e.g., where each company has one or more domains) each owning their own resources. Specifically, if an employee creates a meeting in domain X, then the meeting object exists in the domain X graph. However, the meeting may include participants or other resources from domain Y, and domain Y users will need to see those graph connections as well. The disclosed technology mirrors the resources and graph connections across the Internet so that domain Y's users can also see this meeting in their applications (and, vice versa, so that domain Y resources can be mirrored to domain X, as/if appropriate).

The disclosed technology includes a system and method for managing visitor passes for guest access to software and services. The visitor pass is an intermediary mechanism that allows registered users of a network-based software system to provide conditional access to system resources to guest users of the system without requiring the intervention of an IT administrator. Level of authentication required is driven by policy (e.g., stricter requirements for access to more sensitive resources). Policy examples include, for instance, (a) a guest user can access only documents shared to them by their sponsor, or only access documents related to a specific meeting, guests may not sponsor other guests, guests may not re-share documents to any other user, guests may only use company-authorized applications to access documents, guest access is time-limited, etc., and (b) other guest access policies are possible via a separate policy definition framework that may be implemented in a system.

The disclosed technology provides the ability to “lease” content (e.g., business documents) and revoke or expire access to content after the specified set of conditions are met. A lease is activated when an issuing resource (e.g., a document owner) is ‘accepted’ by a lessee (e.g., an end user account). A lease can define broad usage conditions including conditions that result in revocation of usage, for example, (a) naming specific users, resources, groups, organizations, or domains as potential audience members, (b) limitations on a number of permitted operations, (c) limitations on amount of transferable data, (d) capability to revoke/restrict usage to a set duration after first access, (e) capability to revoke usage after a set date, (f) capability to revoke usage if the state of a network resource is triggered. Access to resources can be limited by stipulations defined in the leases that expire after a preset time, for example, “share for 24 hours, then revoke”. Leases can stipulate a limited set of conditions that can be evaluated/re-evaluated on an as-needed basis (e.g., “on the fly”, for example, (“share starting 2 hours prior to the meeting and ending 24 hours after the meeting.”). Contextual leases may be role-based, time-based, situational-based, etc.

In one aspect, the disclosed technology relates to a system and method for creating and updating a business workflow model (contextual graph) for an enterprise. In some implementations, the method includes: creating, by a processor of a computing device (e.g., a server), for each of a plurality of users associated with the enterprise (e.g., employees of the enterprise, guests of the enterprise, administrators of the enterprise, etc.), a context list specific to the user; transmitting, via a network, for each of the plurality of users, data representing content of a newly created or updated context list corresponding to the user; graphically rendering, on a display of a registered user's computing device, the newly created or updated context list associated with the user following authentication of the user by the processor, wherein the context list is graphically rendered on a timeline, such that contexts populating the context list are positioned on the display in an order reflecting a time associated with each context (e.g., graphically positioned top-to-bottom in sequential order according to time of creation, time of last update, time of expiration of the context, etc.); for each of the contexts, updating, by the processor, the set of resources associated with the context following a change in the set resources associated with the context; and for each of the context lists, updating the context list by eliminating any expired contexts (and/or concealing or not displaying contexts that have aged beyond a predetermined time, or limiting the number of displayed contexts to a given number or data size, or limiting initial display of contexts to a given number or data size of contexts while revealing older contexts upon further scroll-down or other user feedback), and adding new contexts associated with the user or previously-created contexts that are newly associated with the user, and graphically rendering, on the display of the corresponding registered user's computing device, the updated context list.

In some implementations, the creating of the context lists includes, for each of a plurality of contexts: assigning to the context a set of resources associated with the context (e.g., wherein the assigning allows nesting of contexts within other contexts); determining a set of users associated with the context to whom a graphical representation of the context will be made visually available (e.g., determining the set of users that own one or more resources associated with the context, or who are one or more resources associated with the context, e.g., invitees to a meeting); and determining a time associated with the context (e.g., time of creation, time of last update, and/or time of expiration/termination) (e.g., determining a specific duration and/or expiration time to be associated with the context where the context is a fixed-term context, and/or associating an infinite/unlimited duration to the context where the context does not have an expiration).

In some implementations, the method includes creating, by a processor of a computing device (e.g., a server), upon input by a user, a new context by: assigning to the new context a set of resources associated with the context; determining a set of users associated with the new context to whom a graphical representation of the context will be made visually available; and determining a time associated with the new context; and changing, by a processor of a computing device (e.g., a server), upon input by a user, one or more of: (i) the set of resources associated with a given context; (ii) the set of users associated with the given context; and (iii) determining the time associated with the given context.

The context includes one or more projects, meetings, conferences, events, collaborations, ventures, tasks, and/or research endeavors. The set of resources associated with a given context includes one or more persons, documents, locations (e.g., rooms, buildings), devices, assignments, printers, presentation hardware, computers, display monitors, tasks, calendars, documents, multimedia files (e.g., videos), graphics, and audio files. For example, the contexts may be an event (e.g., a meeting) and the method includes assigning to the event a set of resources associated with the event, wherein the set of resources comprises a plurality of persons and, optionally, documents (or a list of, or links to, documents) relevant to the event.

In another implementation, the context is a meeting or conference has a set of resources associated with it, wherein the set of resources comprises one or more of: a set of invitees or participants (e.g., along with their titles, positions, roles at the meeting, employers, guest status, etc.), documents to be presented at the meeting, documents relevant to the meeting (e.g., to be discussed before the meeting), a meeting room and/or location, hardware devices to be used at the meeting (e.g., projection/display equipment), support staff available for the meeting. The method may include authorizing to the invitees, by the processor, access (e.g., read-only access, viewing access) to the documents to be presented at the meeting, where the invitees comprise authenticated users and/or guests of authenticated users. The resources may be remotely accessible by the invitees via one or more computing devices (e.g., smartphones, tablets, desktops, etc.).

The set of resources includes one or more logistical resources, e.g., a meeting room, a start and/or end time, an electronic calendar entry (e.g., local, intranet, or internet-based), a remote connection to the event, an access password or access channel to the event, and/or hardware (e.g., computer(s), projector(s), printer(s)) that are available for the event.

In some implementations, the method includes assigning to the event context a logistics context (e.g., a nested context, e.g., presented as a link) with its own associated set of resources, e.g., a meeting room, a start and/or end time, an electronic calendar entry (e.g., local, intranet, or internet-based), a remote connection to the event, an access password or an access channel to the event, and/or hardware (e.g., computer(s), projector(s), printer(s)) that are available for the event.

In some implementations, the method includes capturing and/or managing metadata associated with one or more of the resources associated with a given context (e.g., where the metadata comprises size of a file, format of a file, creator of a file, character set, encoding, endianness, and the like) (e.g., where the metadata comprises structural metadata, i.e., description of how components of the object are organized, e.g., the structure of a database object such as a table, column, key, or index; guide metadata, i.e., a set of keywords in a natural language to help users find specific items, e.g., technical metadata, i.e., internal metadata, business metadata, and external metadata; process metadata; descriptive metadata, i.e., information used to search and locate an object such as title, author, subject, keyword, publisher, etc.; and administrative metadata, e.g., technical information such as file type, rights management metadata, and preservation metadata).

In some implementations, each resource and/or each context has at least one owner, wherein each owner is a registered user and the resource is associated, in the business workflow model, with the at least one owner. The method may include, prior to changing, upon input by a user, the set of resources, the set of users, and/or the time associated with a given context—authenticating, by the processor, that the user is either an owner or a designee of the owner who is authorized to make the change.

In another aspect, the disclosed technology includes a system and method for secure mirroring of business workflow models among two or more domains. The method, in some implementations, includes creating and/or updating, by a processor of a computing device, for a first domain (e.g., company, institution, group, or business enterprise), a first business workflow model (e.g., contextual graph) associated with the first domain, wherein the business workflow model comprises a plurality of contexts each associated with one or more users within the first domain, each of said plurality of contexts having a set of resources assigned to said context; transmitting, via a first network (e.g., intranet), for each of the one or more users within the first domain, data representing content of a newly created or updated context list corresponding to the user; receiving, via the first network or a second network (e.g., intranet, or internet), by one or more users within the first domain, data representing content of a portion of a second business workflow model (e.g., contextual graph) associated with a second domain (e.g., company, institution, group, or business enterprise), wherein the second domain is different from the first domain, and wherein the portion of the second business workflow model received by the one or more users within the first domain is restricted to a shared subset between the first and second domains (e.g., wherein the shared subset comprises contexts and associated resources of the business workflow models/contextual graphs related to an ongoing collaboration between employees of the first and second domains); and graphically rendering, on a display of a computing device of a registered user of the first domain, a newly created or updated context list from the first business workflow model, wherein the newly created or updated context list comprises contexts belonging to the shared subset.

In some implementations, the method includes creating and/or updating the first business workflow model and the second business workflow model via eventual consistency architecture (e.g., wherein the first and second business workflow models are part of a highly scaled web-based architecture). The method may include establishing and/or enforcing, by a processor of a computing device (e.g., the same or a different processor than that which creates/updates the first business workflow model), semantics for the resources within the shared subset.

The semantics may include modification rules (e.g., the semantics comprise logical structures whereby users of the domain that own a given shared context [e.g., where such users are associated with the shared context] are given permission to modify one or more resources and/or other detail associated with the given shared context, while users of a non-owning domain [e.g., where such users are associated with the shared context] have permission to view the one or more resources, but not to modify the one or more resources) and/or sharing rules (e.g., the semantics comprise logical structures whereby users of a domain that own a given shared context [e.g., where such users are associated with the shared context] are given permission to view and/or transmit one or more resources and/or other detail(s) associated with the given shared context, and/or users of a non-owning domain [e.g., where such users are associated with the shared context] are given permission to view and/or transmit one or more resources and/or other detail(s) associated with the given shared context).

The method, in some implementations, includes intelligent scoping, by a processor of a computing device (e.g., the same or a different processor than that which creates/updates the first business workflow model), data from the first business workflow model and data from the second business workflow model to identify the shared subset between the first and second domains. The method may include intelligent scoping of data associated with a plurality of business workflow models corresponding to a plurality of domains, thereby identifying a plurality of shared subsets amongst the domains.

In another aspect, the disclosed technology includes a method for managing guest access to the enterprise's resources. The method, in some implementations, includes authenticating, by a processor of a computing device, a first user of a system (e.g., a contextual graph system) by analyzing input provided by the first user and determining that the input matches a first set of credentials associated with the first user, wherein the first user is registered with the system and has authorization to access a first set of system resources according to a predetermined access level (e.g., the first user is an employee with non-administrator employee access to system resources) (e.g., wherein resources comprise documents, devices, calendars, locations such as meeting rooms, content produced by and/or associated with a particular user, and/or the like); following authentication of the first user, receiving, by the processor, a request from the first user to authorize a second user for guest access to the system, wherein the second user is not previously registered as a user of the system (e.g., the second user is a non-employee); receiving, by the processor, a second set of credentials associated with the second user (e.g., provided by the first user or by the second user or by both the first user and the second user (e.g., first user provides one credential of the second set of credentials and second user provides another credential of the second set of credentials)); verifying, by the processor, that the second set of credentials associated with the second user meets one or more predetermined criteria for guest-level access to the system (e.g., verifying that the second user is not prohibited by virtue of being listed on a no-access list); and following verification of the second set of credentials, authorizing, by the processor, the second user to access a second set of system resources (e.g., wherein the second set is a subset of (e.g., less expansive than) the first set of system resources) (e.g., wherein the second set of credentials is successfully verified, the second set of resources is of the type that may be accessed by users not registered with the system, and/or the second set of resources does not comprise any restricted or confidential information access to which is restricted to users that are registered with the system), wherein access to system resources by the second user is limited to the second set of system resources.

In some implementations, the method includes, prior to authenticating the first user, registering the first user with the system. The first set of credentials and/or the second set of credentials may include a username, a password, gesture pattern (e.g., predetermined pattern for finger swipe on a touch-sensitive display) or any combination thereof.

The first set of credentials and/or the second set of credentials may include name, date of birth, place of birth, identification number, social security number, telephone number, email address, passport number, employee identification number, company name, group name, business unit name, or any combination thereof (e.g., any other suitable credential used for identification of individuals).

In some implementations, the first set of user credentials and/or the second set of user credentials comprises a biometric characteristic or a combination of multiple biometric characteristics [e.g., one or more fingerprints (including prints of one finger, two fingers, 1-5 fingers, 1-10 fingers, one palm, both palms), iris scan (one or both eyes), retina scan (one or both eyes), facial scan, hand geometry, odor, vein pattern, voiceprint, typing rhythm, gait, dynamic signature, static signature, and any combination thereof].

In some implementations, the second set of system resources includes one or more documents and/or one or more applications identified by the first user as authorized for viewing by the second (guest) user. The second set of system resources may be associated with a triggering event of limited duration or lifetime (e.g., a meeting, a presentation, a project, etc.) and wherein guest access to the second set of system resources is limited by the duration or lifetime of the triggering event (e.g., guest may access the second set of resources only for the duration of the meeting, the presentation, the project, and/or for a predetermined time thereafter, etc.).

The method may include, authorizing, by the processor, the second user to access the second set of system resources if the first user is authorized to permit access to the second set of system resources to users not previously registered with the system and/or if access to the second set of system resources is not restricted only to users registered with the system (e.g., the type of the first set of system resources is such that only users registered with the system (e.g., employees) may access it). The predetermined access level applicable to the first user is configurable as a function of a security clearance level and/or an employment position (e.g., access is configurable as a function of employment position—e.g., an engineer/researcher will have a different access to documents than a receptionist).

For example, the guest-level access to the second set of resources comprises read-only access to the second set of resources (e.g., the second user is not allowed to modify/delete/create documents) (e.g., according to an administrator-configurable policy) (e.g., or, alternatively, wherein the guest-level access permits editing of identified documents, uploading of documents, and/or sharing of documents within the system and/or outside the system, e.g., according to an administrator-configurable policy).

The method may include generating and transmitting, by the processor, to a computing device associated with the second user, a temporary token associated with the second user. The access to the token is restricted to computing devices registered with the system (e.g., company computers or computers previously registered with the system), or to computing devices running an application associated with the system, and/or with pre-approved computing devices.

In some implementations, the method includes transmitting, by the processor, a notification to a system administrator that the processor received the request from the first user to authorize the second user for guest access to the system (e.g., the system administrator is notified anytime someone tries to give any visitor access to the system).

In some implementations, the processor authorizes the second user for guest access to the system without requiring intervention from another user (e.g., without intervention of an IT administrator). The processor may authorize the second user for guest access to the system within a time period corresponding to substantially real time in relation to receipt by the processor of the request from the first user to authorize the second user for guest access to the system. The system may store the second set of credentials and/or other information associated with the second user for future use.

In some implementations, the method includes denying/prohibiting, by the processor, the second user from submitting any request from the second user to authorize any users not previously registered with the system for guest access to the system. In some implementations, only users registered with the system are permitted to submit requests to authorize users not registered with the system for guest access to the system.

In some implementations, the method includes authorizing, by the processor, the second user to access an electronic document and/or other data (e.g., company directory). The method may include authorizing, by the processor, the second user to modify an electronic document and/or other data. In some implementations, the method includes authorizing, by the processor, the second user to operate a device (e.g., a printer, fax machine, projector, computer, electronic lock for conference/meeting room, or the like). The method may include authorizing, by the processor, the second user to access a computational resource (e.g., an offline file format conversion service).

In another aspect, the disclosed technology includes context-sensitive access control. In some implementations, the method includes, for each of at least one of the plurality of contexts, enforcing, by the processor, access and/or use rules for a resource of the context, wherein each of the access and/or use rules have both a time dependence and a situation (context detail) dependence.

The access and/or use rules include one or more of the following: (i) permitting operation of a printer in an authorized room of a first domain by a visitor, but only if the visitor is scheduled to attend a meeting (context) at the first domain, as reflected by the business workflow model for the first domain, and only for an indicated duration corresponding to the meeting; (ii) permitting access to a document by participants of a context (e.g., meeting or other event) only until a selected goal is reached (e.g., completion of a project that is the context, or is associated with the context); and (iii) permitting access to a resource only upon prompted re-authentication by the user, acknowledgment of TOC, acknowledgement of compliance obligations, and/or acceptance of IP license terms at a point of access to the resource.

The access and/or use rules may incorporate one or more of the following: (i) no confidential document (resource) of an owner domain can be shared with a third party (e.g., domain other than the owner domain) unless that third party has signed a non-disclosure agreement with the owner domain; (ii) no meeting resource of an owner domain can be mirrored to a third party (e.g., domain other than the owner domain) if the meeting includes a named officer (e.g., CEO or CFO) of the owner domain; and (iii) resources of an owner domain must be encrypted with a domain-approved DRM scheme if they are exposed to any third party (e.g., domain other than the owner domain).

In another aspect, the disclosed technology includes a system and method for user-specified graph extension and platform performance hooks. In some implementations, the method includes, for each of one or more of the plurality of contexts, assigning to the context a customized graph object (e.g., software) that is operable by the set of users associated with the context (e.g., wherein the customized graph object is a program). In some implementations, (i) the customized graph object provides tracking of metadata concerning documents that are not provided in a base document class; (ii) the customized graph object can be mirrored between domains as per built-in resources that are shared among two or more domains; and/or (iii) the customized graph object is subject to a security policy framework.

In another aspect, the disclosed technology includes lease-based access control. One or more of the plurality of contexts is a lease context, wherein the lease context specifies usage conditions of one or more resources associated with the lease context that limit usage and/or access to the associated resource(s). The lease context may be activated when an issuing resource (e.g., a document owner) is accepted by a lessee (e.g., an end user account).

In some implementations, the lease object defines usage conditions that result in revocation of access and/or usage rights (e.g., (i) naming specific users, resources, groups, organizations, or domains as potential audience; (ii) limitations for number of permitted operations; (iii) limitations for amount of transferable data; (iv) revocation of usage to a set duration of time after first access; (v) revocation of usage after a set date; and/or (vi) revocation of usage if the state of a network resource is triggered) (e.g., wherein the lease object is role-based, time-based, and/or situation-based).

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a screenshot of an exemplary graphical user interface of a context list of contextual collaborations;

FIG. 2 is a screenshot of an exemplary graphical user interface of a contextual collaboration;

FIG. 3 is a flowchart illustrating a method for creating and updating a business workflow model (e.g., a contextual graph) for an enterprise;

FIG. 4 is a screenshot of an exemplary graphical user interface of a contextual collaboration workspace;

FIG. 5 is a block diagram that illustrates a system for enterprise management using contextual graphs;

FIG. 6 is a block diagram that illustrates a system for enterprise management using contextual graphs presented as contextual collaborations;

FIGS. 7A and 7B are screenshots of an exemplary graphical user interface of a contextual collaboration workspace;

FIG. 8 is a screenshot of another exemplary graphical user interface of a contextual collaboration workspace;

FIGS. 9A through 9F are screenshots of an exemplary graphical user interface for handling files associated with a contextual collaboration;

FIGS. 10A and 10B are screenshots of an exemplary graphical user interface for managing tags associated with a contextual collaboration;

FIG. 11 is a screenshot of an exemplary graphical user interface for creating a contextual collaboration from an operating-system workspace;

FIG. 12 is a screenshot of an exemplary graphical user interface for creating a contextual collaboration from an electronic mail;

FIG. 13 is a flowchart illustrating a method 1300 for creating a collection of contextual collaborations for users associated with an enterprise;

FIG. 14 is a flowchart illustrating an example method for enterprise management and access control;

FIG. 15 is a flowchart illustrating a method for secure mirroring of business workflow models among two or more domains;

FIG. 16 is a screenshot of a collaboration icon within a system icon tray for setting presence status within the contextual collaboration system;

FIG. 17 shows a block diagram of an exemplary cloud computing environment; and

FIG. 18 is a block diagram of a computing device and a mobile computing device. The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Headers are used herein to aid the reader and are not meant to limit the interpretation of the subject matter described.

In certain embodiments, the disclosed technology includes an enterprise system that provides contextual graphs (e.g., a contextual collaboration) that relate “resources” that occur in business workflows by providing a unified collaborative tool and workspace to access people, resources, and tools within the context of completing a project or task. Files, users, permissions, priorities, individual tasks, statuses, and assets are grouped in a single unified workspace that is centered around the context of completing the task or project. The system streamlines the way that projects or tasks are completed while providing a system of record for the project or task that is neatly and intuitively organized within the context of that project or task.

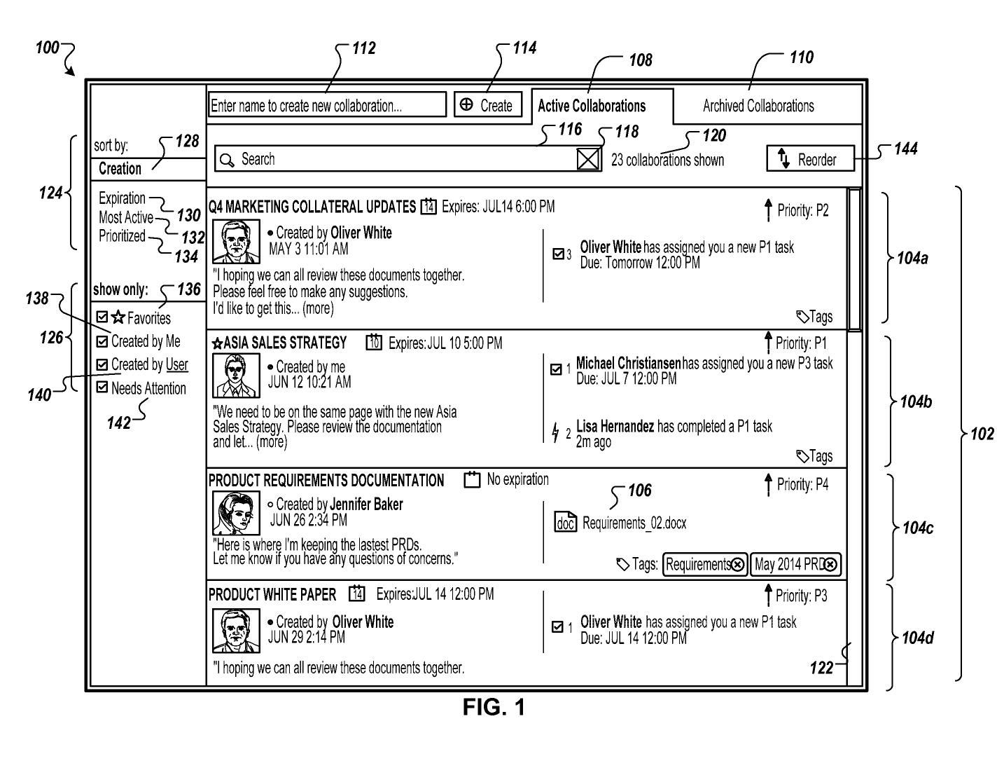

FIG. 1 is a screenshot of an exemplary graphical user interface 100 of a context list 102 of contextual collaborations (shown as 104a-d). The context list 102 of a user includes the contextual collaborations to which the user is associated and is customized to that user.

Workspaces (i.e., individual contextual collaboration) that are shared with other users are made available to these users to which the users can contribute and share information, documents, and resources. The users may include those that are within the same organization/business domain(s), as well as users external to such organization/domain(s).

The context list 102, in some implementations, is graphically rendered such that the contextual collaborations (e.g., 104a-d) populating the context list 102 are positioned on a user's display based on a criterion provided by the user (e.g., in an order reflecting a priority status or time associated with each contextual collaboration), or according to a default setting. Each of the contextual collaborations of the context list graphically indicates one or more of the following associated therewith: files, users, priorities, tasks, statuses, and assets.

To promote ease of viewing and accessing of the information within the contextual collaboration, elements of the contextual collaboration (e.g., user information, collaboration name, conversations, expiration information, priority value, tags, files/tasks) are designated certain areas within the contextual collaboration and are graphically presented in the same areas among the contextual collaborations within a given context list. To this end, each of the associated components are graphically displayed in an area of a given presentation space reserved for the given contextual collaboration, such that, collectively, the components associated with a presented contextual collaboration are graphically aligned in the presentation space among a collection of contextual collaborations.

From the context list 102 of contextual collaborations 104, the system presents an overview of tasks within each contextual collaboration 104. This overview gives an update of tasks relating to a user. In some implementations, the task can take two forms: tasks that another user has assigned to the user and tasks that the user has assigned to other users.

In some implementations, the system selectably presents between the active collaboration and archived collaborations. Archived collaborations, in some implementations, cannot be modified. Users may search the archived collaborations and view them within the collaboration detailed window, which allows the users to view information associated with a contextual collaboration and change settings associated with the contextual collaboration.

### Contextual Collaboration

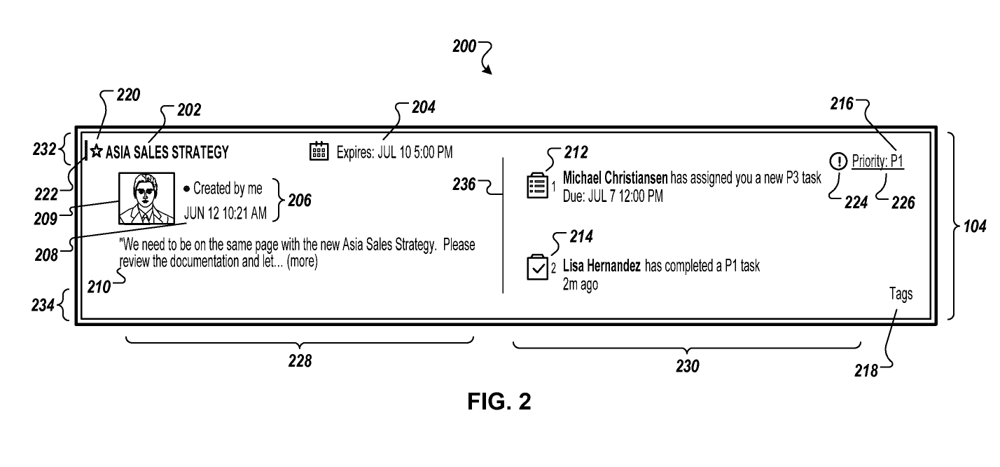

FIG. 2 is a screenshot of an exemplary graphical user interface 200 of a contextual collaboration 102, as shown in FIG. 1.

The contextual collaboration 102, in some implementations, includes and graphically indicates one or more of the following: a title 202 for the contextual collaboration (provided by the user and preferably descriptively indicating a project goal or task); an expiration date and/or time 204 for the contextual collaboration; a collaboration owner 206 (and/or user icon/avatar); a creation time 208 of the collaboration; conversations/communication 210 among the various users associated with the contextual collaboration; sub-tasks 212 delegated and assigned within the contextual collaboration; statuses 214 associated with activities and completions of sub-tasks within the contextual collaboration; documents/files and/or resources 106 (see FIG. 1) associated with the contextual collaboration; priority level 216 of the contextual collaboration; tags 218 associated with the contextual collaboration; favorite indicators 220; and change indicators 222.

A contextual collaboration may be modified by a user (e.g., the creator/owner of the contextual collaboration) to add and/or remove other users; add and/or remove other owners; add and/or remove files/documents/resources; instantiate live-share; edit and apply version numbers of files/documents; set permissions; set priorities; set expiration date and time; delete and archive the contextual collaboration; and change states of the contextual collaboration.

As used herein, a user is a person who is registered with the system, and can (i) log into the system, (ii) execute commands, and (iii) receive events and notifications. In some implementations, the owner includes a user that has uploaded a specific file (namely, a document owner) or who has created a contextual collaboration (namely, a collaboration owner). Document and/or collaboration owners have greater privileges with respect to the document or collaboration to which they own than other users.

A participant is a person associated with a contextual collaboration. A participant can be a user or a collaboration owner.

The system, in some implementations, allows a collaboration owner (e.g., a user that creates a given contextual collaboration) to add or remove other users from a contextual collaboration; add or remove files from the collaboration; share files among the users through a contextual collaboration; work on a file associated with or shared through a contextual collaboration (e.g., by editing a file [e.g., using the native application] and publishing new versions of the files through the contextual collaboration); comment on a file associated with a contextual collaboration; assign and/or complete tasks assigned through a contextual collaboration; approve and/or reject a file through a contextual collaboration; share a file in real time with other users through a contextual collaboration; and/or communicate with other users within a contextual collaboration.

In addition, the system, in some implementations, allows the collaboration owner to grant permissions to other users to perform actions of the collaboration owner. For example, the system may allow other users to add or remove users to the collaboration; allow other users to add or remove files from the collaboration; allow other users to share files among the various users associated with the collaboration; allow other users to work on a file (e.g., by editing a File (e.g., using the native application) and publishing new versions of the files; allow other users to comment on the file as a whole (e.g., within the collaborative workspace); allow other users to assign or complete tasks assigned by other(s) pertaining to a file or collaboration; allow other users to approve or reject a file (as required); allow other users to share a file in real time with other users; and/or allow other users to communicate with various users within the collaboration.

In some implementations, permissions provide the ability to allow or restrict certain rights and privileges of other users in a collaboration or specific to a file. Permissions are applied by owners of either the collaboration or file and can be modified from a set of pre-defined options and settings within the system.

Resources have a lifecycle and exist in at least one context, and those contexts can be created, manipulated and ultimately terminated or retired. The graph structure relates resources into these contexts and places the contexts, in some implementations, conceptually on a timeline and/or by priority. To this end, at any point in time a user of the system can view their timeline or priority and see what contexts (and therefore what resources within those contexts) are involved in the activities they are working on.

For example, a contextual collaboration can be in connection with the production, approval, and archival of documents (and/or files).

In further example, a context could be framed as a meeting with relationships or links to: the attendees of the meeting, the documents to be presented in the meeting, devices (projectors or displays) that the meeting will use, and the location(s) of the meeting and/or the scheduled time. This graph information model, which may be presented in a contextual collaboration, is exploited by the platform and applications to orchestrate the meeting. For example, read access to the documents may be automatically granted to the attendees of the meeting once the documents and attendees are associated with/within the contextual collaboration. Similarly, the documents may be automatically available for display on any display available in any of the meeting locations if associated within the contextual collaboration.

In some implementations, the graph is employed to facilitate better user experience in difficult use cases, e.g., if one participant must attend a meeting via smartphone or offline, the documents can be pre-staged on that user's device prior to the scheduled meeting. This allows explicit modeling and storage/manipulation of these resources in a data structure such that these orchestration processes can be achieved efficiently and effectively. Resources have configurable visibility or access rules (meaning a resource may be visible only to certain people but not to all). Visibility may be controlled and modified by users of the system (subject to company policies, e.g., the policy may be such that only the creator of a meeting context can change its attendees or scheduled date). Resources may be owned by their creator but the ownership itself can be transferred to someone else (i.e., delegation, or transfer of responsibility to a different division, or even a merger/acquisition).

Contextual collaborations may involve resources (e.g., people or content) from more than one domain (e.g., where each company has one or more domains). For example, if a user creates a meeting in domain X, then the meeting object exists in the domain X graph. However, the meeting may include participants or other resources from domain Y, and domain Y users will need to see those graph connections as well. The system may mirror the resources and graph connections across the Internet so that domain Y's users can also see this meeting in their applications (and vice versa, domain Y resources can be mirrored to domain X as appropriate). This mirroring system may follow an “eventually consistent” design pattern that is used in a large web services architecture.

Resources may include files, which describes any piece of data. In some implementations, the data includes a text/word processing document, a spreadsheet, a presentation, an image, a video, an email, a sound file, etc. The data may include file series, which is a set of versioned files.

Resources (people, content, devices, etc.) are protected by a fine grained security model. The graph context may be leveraged in the decision whether to grant access to a given resource. This decision can be highly dynamic (i.e., time dependent as well as situation-dependent). For instance, a visitor may have the right to print a document on the printer in the conference room, but only if that visitor is scheduled to attend a meeting in that conference room and the printer is available only for the duration of the meeting. Similarly, a document is made available to participants of a context only until the goal of the context is reached.

In some implementations, the disclosed technology operates in conjunction with a system for providing and managing a visitor pass. In some implementations, a visitor pass is an intermediary mechanism that allows registered users of a network-based software system to provide conditional access to system resources to guests. A visitor pass may allow a guest conditional access to the system without requiring the intervention of an IT administrator. The level of authentication required may be driven by an access policy. For example, there may be stricter requirements for access to more sensitive resources. The visitor pass may support an extensible authentication that can be triggered based on an access policy.

Guest access may be governed by preset and/or configurable policies that can limit what data they have access to, and/or limit what operations they are able to perform. Policy examples include (a) a guest user can access only documents shared to them by their sponsor, or only access documents related to a specific meeting, guests may not sponsor other guests, guests may not re-share documents to any other user, guests may only use company-authorized applications to access documents, guest access is time limited, etc., and (b) other guest access policies are possible via a separate policy definition framework implemented in some embodiments of the present invention.

The disclosed technology includes search engine capabilities to allow users to search through stored metadata for relevant collaborations, files, and users. In some implementations, the system utilizes a Virtual Storage Service (VSS), whereby the service allows for different connectors to a company's storage assets. The Common Internet File System (CIFS), in some implementations, is employed as the file storage system and provides a connector between VSS and the corporate CIFS systems.

The disclosed technology allows users within the proper domain to access the system without the need for a VPN connection. The disclosed technology allows for the setting of priorities for the collaborations at either a system or personal level to allow the user to determine the importance and act accordingly.

In some implementations, the system allows for the provisioning of the system to a specific number of users. The system may interact directly with the operating system to add files to the system. The disclosed technology allows for users to communicate via instant messaging client through a thick client application that allows users to access all the available features and functions provided.

The contextual collaboration allows users to comment on the document, to delegate and assign tasks, and to request and provide approval of a draft of the document. In some embodiments, the disclosed technology includes a system that allows for the commenting of specific files (note, not in the file itself) and contextual collaborations to which users can assign and/or act on tasks associated with a given file. The disclosed technology also allows for the addition of comments and tasks to the contextual collaboration as a whole.

The users may include people within a given domain (e.g., internal to the organization or company). Invitees may be authorized to access (e.g., read-only access, viewing access) to the files and collaborative workspace associated with the event, such as those to be presented at the meeting. The system may perform this authentication automatically, allowing the invitees to access all documents or other resources associated with the meeting without the assistance of an IT department. The system may allow, for example, the invitees to access the relevant resources remotely via one or more computing devices (e.g., smartphones, tablets, desktops, etc.).

The contextual collaboration archives the interaction among the users to which the information can be subsequently viewed. In some implementations, the collaboration is accessible for viewing, but locked from further editing after the expiration date for the collaboration has passed.

In some implementations, the system sends a notification to all participants when a new file, new task, or new user is added to a context/collaboration to which the participant is associated. In some implementations, the system sends notification when a status of a user, file, or task is changed. In some implementations, the system sends a notification when any changes are made to the context/collaboration.

To promote ease of use, the system may allow configurations of a given contextual collaboration to be modified directly on a contextual collaboration of the contextual list 102. As shown in FIG. 2, in some implementations, the contextual list 102 includes one or more graphical widgets to initiate a dialogue box or to effect a change to a contextual collaboration. A priority indicator 216, or a graphical portion thereof, for example, is rendered as a widget comprising a graphical icon 224 and a corresponding text 226. The indicator 216, in some implementations, provides an input to the system to modify (e.g., to increment or decrement) the priority level among the selectable levels provided by the system and/or initiates a dialogue box to select a value. In some implementations, the text 226 may be rendered as a link.

The expiration date and/or time 204, in some implementations, also includes a widget to allow for direct modification of the expiration date or time through the contextual list 102. The calendar widget, in some implementations, prompts a dialogue box to be opened. Alternatively, the contextual collaboration can be expanded to display a calendar when the calendar widget is selected by the user.

As indicated, to promote ease of viewing and accessing of the information within the contextual collaboration, elements of the contextual collaboration (e.g., user information, collaboration name, conversations, expiration information, priority level, tags, files/tasks) are designated certain areas within the contextual collaboration and are graphically presented in the same areas among the contextual collaborations within a given context list.

In some implementations, as shown in FIG. 1, each contextual collaboration 104 is organized such that the collaboration creator/owner and the creation time are displayed in a first area 228 of the contextual collaboration 104, and files, tasks, and updates thereof are displayed in a second area 230. In such implementations, conversations (or correspondences and/or messages) between users may be rendered in the first area 228.

The system, in some implementations, renders these areas 228, 230, in a scrollable manner to allow users to view all contents associated with the contextual collaboration 104 from the contextual list 102. Certain areas, such as areas 228 and 230, may be shown separated by a graphical indication 236 of a border. The border 236, in some implementations, is graphically aligned to one another in the context list 102.

In some implementations, the contextual collaboration 104 includes a third display area 232 (e.g., at the header of a given collaboration) to display the collaboration name 202, expiration date 204, and sorting criterion (e.g., priority level or time). Icons indicating priority indicator 216, favorite widget 220, and change widget 222 may also be displayed in the third area 232.

The priority indicator 216 shows the priority level of the contextual collaboration. In some implementations, an owner of a contextual collaboration can set the priority level for the contextual collaboration, which cannot be changed by other users, unless given permission to do so by the owner. Priority levels, in some implementations, are selectable from a pre-defined set of levels and include, for example: low, normal, medium, and high. In some implementations, a contextual collaboration is assigned a normal priority level when the collaboration is created.

In some implementations, the priority level is employed to prompt notifications and/or activities report to the user by the system. For example, contextual collaborations designated with a low priority level, in some implementations, do not trigger the system to generate such prompts. Standard default priority, in such implementations, generates collaboration specific activity reports and notifications. Priority levels, in some implementations, are employed as search or filter criteria in the presentation of contextual collaboration to a given user.

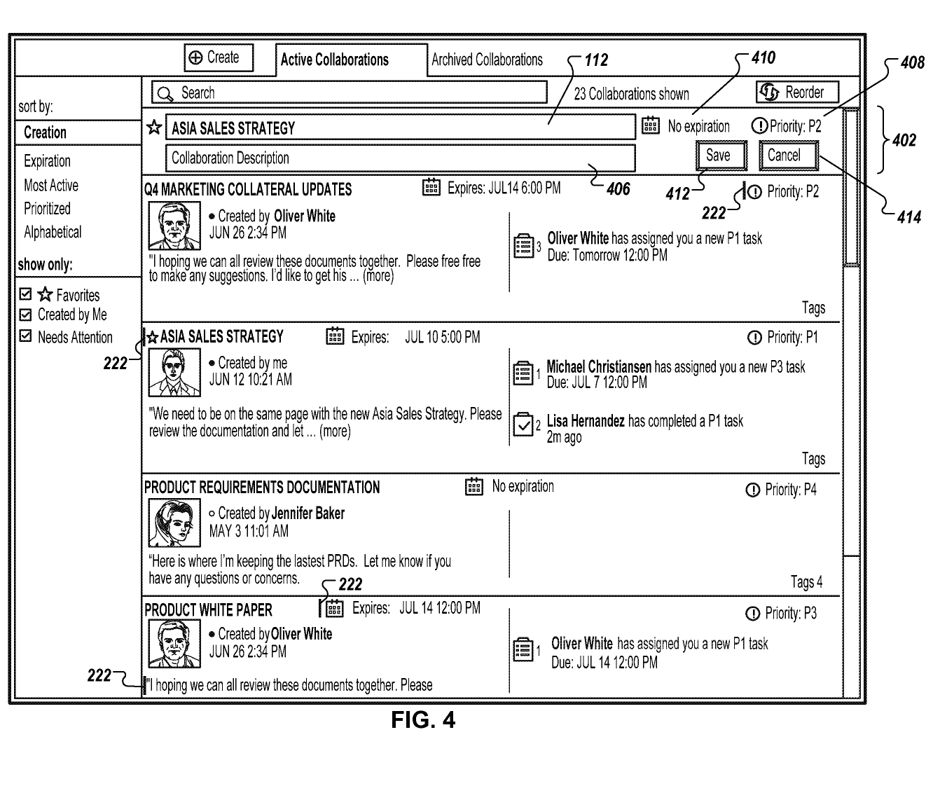

The change widget 222 of a contextual collaboration indicates that a modification or change has been effected since, for example, the last time that the contextual collaboration has been presented to the user. In some implementations, the change widget 222 is presented within a given contextual collaboration until the specific change in the contextual collaboration has been presented to the user. This may involve the user having to scroll through portions of the contextual collaboration, or the widget 222 have to be rendered for a pre-defined period of time. In some implementations, the contextual collaboration 104 is displayed with the most recent changes (e.g., new conversations 210, new statuses 214, or new tasks 212) within the context list 102. In other implementations, the change widget 222 is presented next to the elements of the contextual collaboration 104 that has changed, for example, as shown in FIG. 4.

The favorite widget 220 indicates that a contextual collaboration 104 has been marked as a favorite by the user (i.e., the user has provided an input to the interface 100 to designation such an indication). By setting a contextual collaboration to favorite status, the user can filter by favorites for quick identification of a given contextual collaboration.

The contextual collaboration 104, in some implementations, includes a fourth display area 234 (e.g., at the foot of a given collaboration or lower edge corner of the given collaboration) to display a tags-widget 218. The tags-widget 218, in some implementations, provides an input to the system to selectably expand and collapse the presentation of, within the context list 102, tags associated with a given contextual collaboration 104.

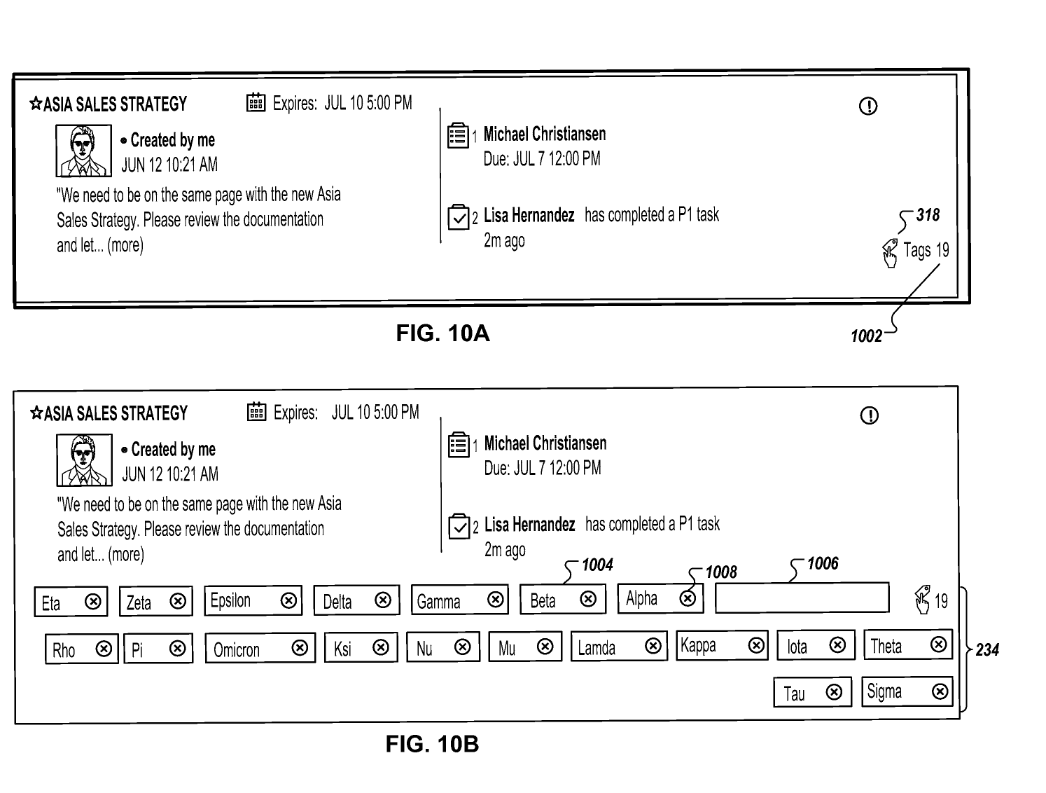

FIG. 10A, for example, is a screenshot of a contextual collaboration with tags in the collapsed state, and FIG. 10B is a screenshot of the contextual collaboration with tags in the expanded state. As shown in FIG. 10A, the tags-widget 218, in some implementations, is presented in the context list 102 and along with a number of associated tags (1002). As shown in FIG. 10B, the tags section (e.g., of the fourth area 234) includes a graphical renderings of the tags 1004 and an input 1006 to add new tags to the contextual collaboration 104. Tags may include arbitrary keywords that are associated with a contextual collaboration that can subsequently be used in a search. The rendering of the tags may each include an input 1008 to allow for the removal of a given tag 1004 from the contextual collaboration. In some implementations, the system associates tags with a user and not with a contextual collaboration. To this end, a tag created by a user is not searched by other users. In some implementations, the user can share tags such that the tags of a given contextual collaboration can be search by other users to which these users are associated.

The various display areas 228, 230, 232, and 234, in some implementations, are aligned within the context list 102 to allow the users viewing the contextual list 102 to readily identify the elements of a given collaboration.

### Contextual Collaboration States

A contextual collaboration, in some implementations, has one of four selectable states at any given time that denotes the life cycle of the contextual collaboration. In some implementations, the states include an active state, an expired state, an archived state, and a deleted state (also referred to as an active contextual collaboration, an archived contextual collaboration, a deleted contextual collaboration, and an expired contextual collaboration). In other implementations, the selectable states include more than four states, for example, a user-defined or organization-defined state (which, e.g., may be added by the system administrator).

As shown in FIG. 2, in some implementations, the contextual list 202 is graphically rendered within navigable tabs 206 to allow the users to access contextual collaboration in the different states. For example, the tabs 206 allow access to active collaborations 208 and archived collaborations 210. Expired collaborations, in some implementations, are searched and displayed with active collaborations. Deleted collaborations, in some implementations, are specific to a given user and are applied to that given user. To this end, other users that have not deleted the contextual collaboration may still see and access that contextual collaboration.

In some implementations, collaboration states are only changed by a collaboration owner (and/or system administrator). In some implementations, an active collaboration is modifiable to the archived or expired state; an expired modifiable to archived state; and an archived state modifiable to a deleted state. In such implementations, the states are not modifiable in the reversed order. In some embodiments, changing of collaboration states are delegable to other users if those users are assigned as a collaboration owner.

An active collaboration, in some implementations, is one that is presently being referenced and/or updated by users/owners and is modifiable by users and owners depending on the permissions applied. The interface 200 lists active collaborations via navigable tab 208. Active collaborations can be searched via the searching function. Active collaborations can be forced to expire; they can also be archived and deleted.

In some implementations, active collaborations are configured with sub-states, for example, a locked and an unlocked mode. When in the locked mode (e.g., by the collaboration owner), no updates or modifications of any type may be executed on the collaboration except by an owner. Permissions still apply to user's access; however no users or files may be added to the collaboration. When in the unlocked mode, any updates or modifications may be executed to the collaboration based on permission settings for a respective user.

An expired collaboration is one that has reached its expiration date or has been designated as expired. Expired collaborations, in some implementations, are accessible by all participants however they cannot be modified in any manner. Files and documents within an expired collaboration, in some implementations, are still accessible by participants. In some implementations, an expired collaboration cannot be restored to active (except by a system administrator). Expired collaborations are included in the active collaborations list and are searched and presented from a performed search. When a contextual collaboration expires, the state is reflected for all participants.

Setting an expiration date for a contextual collaboration, in some implementations, is optional and this functionality is only accessible by the collaboration owner. In some implementations, a document owner can specify an expiration date for a document. By default, contextual collaborations are set to never expire.

An archived contextual collaboration, in some implementations, behaves like an expired collaboration except that they are not returned in a search for contextual collaborations from the active list. Archived collaborations must be searched specifically (e.g., through the navigable tab 210) and the search of archived collaborations does not include any active or expired collaborations. An archived collaboration, in some implementations, cannot be restored to an active state (except by a system administrator). When a contextual collaboration is archived, this state is reflected for all users and owners.

To delete a contextual collaboration, in some implementations, the collaboration must be in the archived state. In some implementations, the system prevents a contextual collaboration in the active or expired state from being deleted—the contextual collaboration must be archived first, then deleted. In some implementations, a deleted collaboration is specific only to a given user performing the deletion. To this end, if a user deletes an archived collaboration, other user associated with a contextual collaboration may retain the collaboration in such user's archive.

In some implementations, to create a contextual collaboration, the user specifies only a collaboration name. Referring still to FIG. 1, the system, in some implementations, graphically renders a text input 212 and widget 214 to create a new collaboration. Additional information and settings for the contextual collaboration (e.g., collaboration description, users, files/documents, priority level, permissions, favorite, expiration date, states, tasks, and other configurations as described herein), can be added later, if desired, for example, when the contextual collaboration is in the active state.

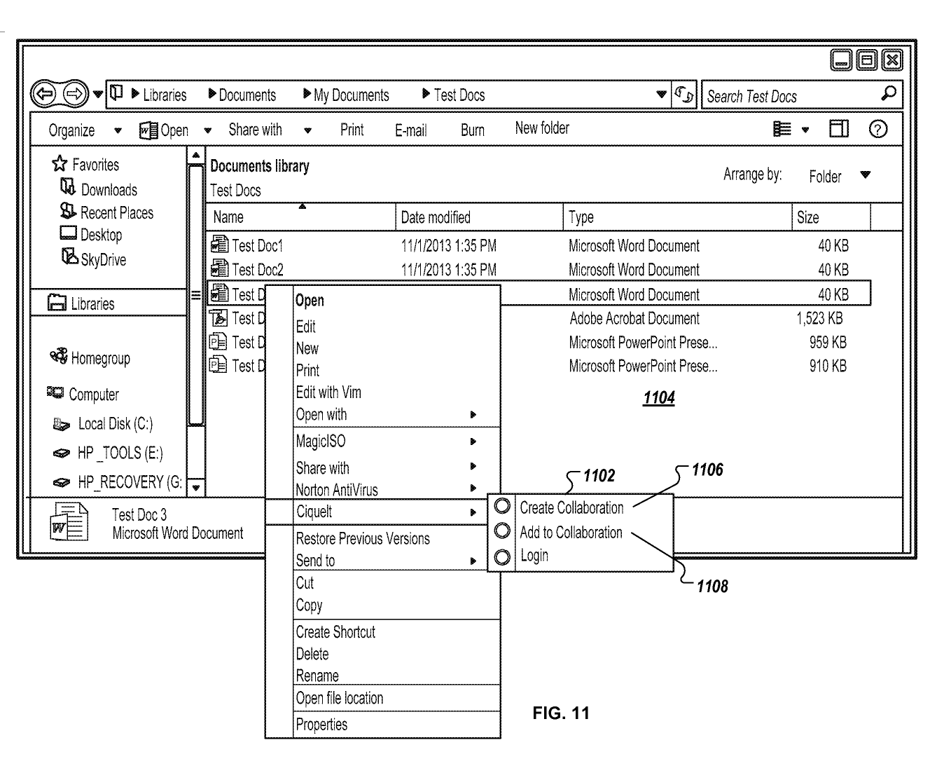

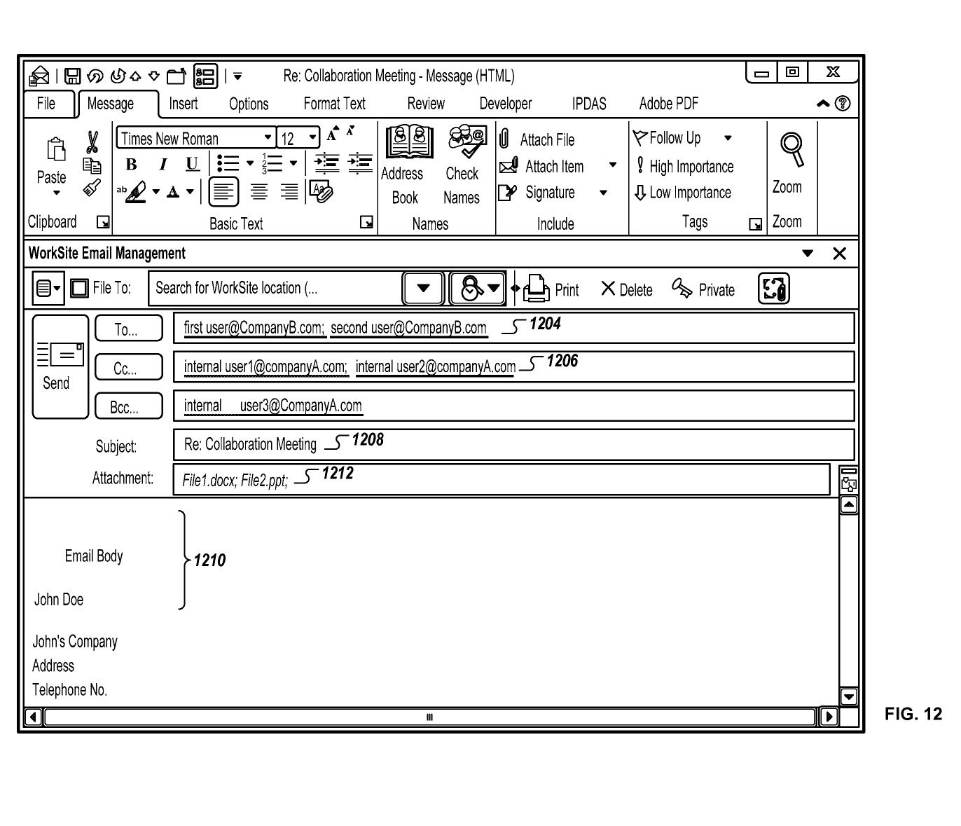

As shown in FIG. 1, the system receives a name for a new collaboration within the text input 112. An <Enter> command in the text input 112 or a graphical input via the widget 114 initiates the creation of the new collaboration. Contextual collaboration, in some implementations, can also be added by the user through the operating system window and from email integration, as described in relation to FIGS. 11 and 12. In some implementations, upon clicking on the button 214, the interface 200 expands to show a “create new collaboration” area 402. FIG. 4 is a screenshot of an exemplary graphical user interface of an active collaboration with a “create new collaboration” area 404.

As shown in FIG. 4, the user can add a collaboration description 406, if desired, as well as set the collaboration priority 408 and/or expiration date 410. Clicking the “Save” widget 412 adds the contextual collaboration to the system. The “Cancel” widget 414 aborts the addition of the contextual collaboration.

In some implementations, the system requires an input from the user for the name 302 in order for a new contextual collaboration to be added. The name 302, in some implementations, is modifiable only by the creator of the contextual collaboration.

In some implementations, the default priority level is set as normal when a new contextual collaboration is created. The priority level can be changed in the “create new” contextual collaboration area 402. The creator of a contextual collaboration is the owner of the collaboration. The collaboration owner may assign owner privileges to other users registered within the system. Users with these privileges, also now owners, can perform all the tasks as the original creator of the collaboration.

As shown in FIG. 1, the interface, in some implementations, displays the number of collaborations 120 shown within the presentation space of the context list 202. The interface may render a scrolling widget 222 to allow navigation among the presented contextual collaboration 204.

### Searching and Filtering

Still referring to FIG. 1, in some implementations, the interface includes a search input 116. The search input 116 causes the system to filter and display the contextual collaborations 104 that meets the search criterion to which a user has access. The search may include keywords of any elements of collaboration (e.g., the name, expiration information, priority, conversation, tasks, statuses, due dates, documents, tags, creation time, etc.). The search input 216 may include a reset widget 218 that resets the filtering criterion which causes all collaborations (either active or archived depending on the navigable tab 208, 210) associated with the user to be presented. A search engine may perform both indexing and searching of data.

In some implementations, the system graphically renders sorting options 224 and filter options 226. The options 224, 226 may display selectable text widget 228, icons 230, and checkboxes 232 to promote quick identification of such options by the users. The sorting options 224, in some implementations, include selectable sorting criteria, which are based on, for example, creation information 228, expiration information 230, most active collaboration 232, and priority value 234. The filter options 226, in some implementations, include selectable filtering criteria, which are based on, for example, favorites 236, created by an author 238, created by a defined user 240, and attention needed 242. The “attention needed” criterion displays contextual collaborations to which a user is assigned an action (e.g., a task or a request [e.g., approval request]).

The interface, in some implementations, includes a reorder widget 244 that allows the user to arrange the order of the contextual collaboration (e.g., via a dialogue box or a selectable list of sorting options).

### Contextual Graph Information Model

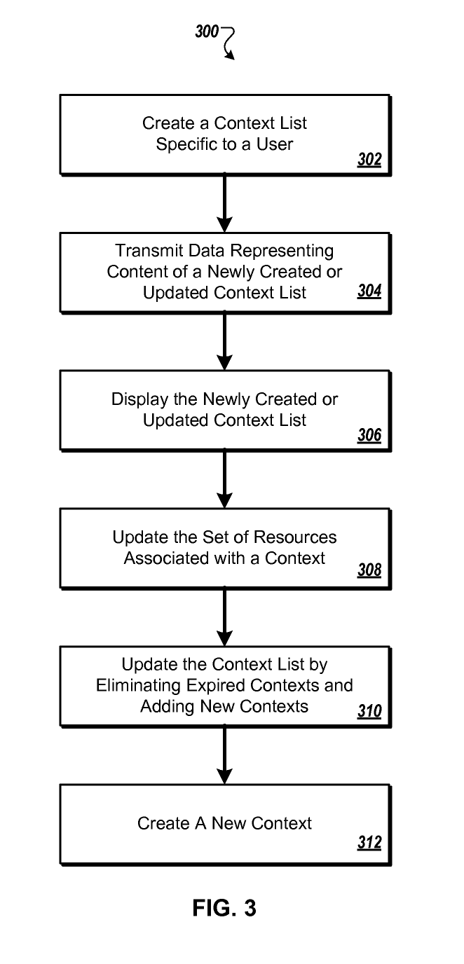

FIG. 3 is a flow chart illustrating a method 300 for creating and updating a business workflow model (e.g., a contextual graph, e.g., a contextual collaboration) for an enterprise. In some implementations, the method 300 includes creating a context list of contextual collaboration specific to a user (302). A context list may be created for each user associated with the enterprise (e.g., employees of the enterprise, guests of the enterprise, administrators of the enterprise, etc.). Each context list 102 is tailored to a specific user or group of users and contains one or more contexts (namely, contextual collaboration 104). Each contextual collaboration 104 includes one or more projects, meetings, conferences, events, collaborations, ventures, tasks, and/or research endeavors.

The system determines a set of users associated with each contextual collaboration 104 on a context list 102. These users are the individuals to whom a graphical representation of the context 104 will be made visually available. The association may be based on, for example, whether the users own one or more resources associated with the context, whether the users are one or more resources associated with the context, and/or whether the users are invitees to a meeting.

A set of resources associated with each contextual collaboration is assigned, via a processor, to the respective contextual collaboration.

For example, a contextual collaboration may be related to an event, such as a meeting or conference. A set of resources associated with the event may be assigned to the event. The set of resources includes a set of invitees or participants (e.g., along with their titles, positions, roles at the meeting, employers, guest status, etc.), documents to be presented at the meeting, documents relevant to the meeting (e.g., to be discussed before the meeting), a meeting room and/or location, hardware devices to be used at the meeting (e.g., projection/display equipment), and/or support staff available for the meeting. Invitees may be authorized to access (e.g., read-only access, viewing access) to the resources associated with the event, such as those to be presented at the meeting. The system may perform this authentication automatically, allowing the invitees to access all documents or other resources associated with the meeting without the assistance of an IT department. The system may allow, for example, the invitees to access the relevant resources remotely via one or more computing devices (e.g., smartphones, tablets, desktops, etc.).

When a user views a context list, they will be able to access the resources assigned to a contextual collaboration in the context list. Examples of resources include one or more persons, documents, locations (e.g., rooms, buildings), devices, assignments, printers, presentation hardware, computers, display monitors, tasks, calendars, documents, multimedia files (e.g., videos), graphics, and audio files. Each resource and/or each context has at least one owner. Each owner is a registered user and the resource is associated, in the business workflow model, with each of its owners.

Contextual collaborations may also be assigned to another context as a nested contextual collaboration. In some implementations, contextual collaborations may be nested within another contextual collaboration using links. For example, a logistics contextual collaboration may be assigned to an event context. The logistics context may have its own associated set of resources, such as a meeting room, a start and/or end time, an electronic calendar entry (e.g., local, intranet, or internet-based), a remote connection to the event, an access password or access channel to the event, and/or hardware (e.g., computer(s), projector(s), printer(s)) that are available for the event.

In some implementations, a time is associated with each context. The time may be a time of creation, time of last update, and/or time of expiration/termination. A specific duration and/or expiration time may be associated with the contextual collaboration. The context may also have an infinite/unlimited duration such that the context does not have an expiration date or time.

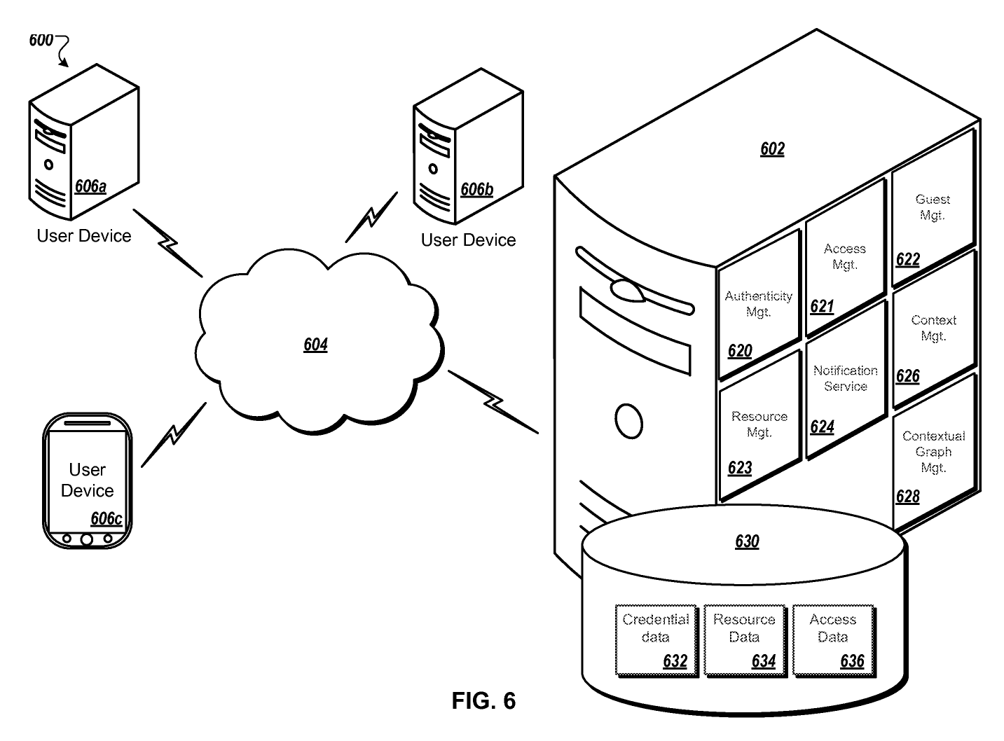

After creating or updating a context list, data representing the content of the newly created or updated context list is transmitted to a user (304). The data may be transmitted via a network, such as the network 604 described in relation to FIG. 6. The newly created or updated context list associated with a user is displayed on a graphical user interface the user's computing device (306).

The context list 102 may be graphically rendered on a timeline, such that contexts populating the context list are positioned on the display in an order reflecting a time or priority level associated with each context. For example, the contexts on the context list may be graphically positioned top-to-bottom in sequential order according to the priority level associated with the contextual collaboration, priority level associated with contents within the contextual collaboration, time of creation, time of last update, and/or time of expiration of the context as shown in FIG. 1.

The resources associated with a contextual collaboration may change over time. Resources may be added to or removed from a contextual collaboration. When the resources associated with a contextual collaboration are changed, the change is updated to all the users associated with the contextual collaboration.

Context lists may change over time as associations between contextual collaborations and resources or users change, as contextual collaborations are added, and as contextual collaborations are removed. Context lists are updated to reflect these changes (308). The system may authenticate that a user is either an owner or a designee owner who is authorized to make changes to a context list or context. The context lists may be updated periodically or in real time for a given user when changes to the context list are made by any of the other users.

A context list is updated for a given user by eliminating any expired contexts or by adding new contexts associated with a user or previously-created contexts that are newly associated with the user (310). In some implementations, the expired contexts are displayed in a separate workspace (i.e., an expired or archived workspace) separate from the active collaboration/contexts. Updating the context list, in some implementations, includes concealing or not displaying contexts that have aged beyond a predetermined time, limiting the number of displayed contexts to a given number or data size, or limiting initial display of contexts to a given number or data size of contexts while revealing older contexts upon further scroll-down or other user feedback. After updating a context list, the updated context list is provided for display on a corresponding registered user's computing device.

In some implementations, when the user creates new contexts, the user can assign a set of resources to the new context and/or select a set of users to whom a graphical representation of the next context should be made visually available (312). These users are associated with the context. The system may also associate users with a new context based on information provided by a user. For example, a user may create a new context that should be associated with users of a specific group within an enterprise. Owners can add to the next context, as well as non-owners if provided permissions by the owners to do so. In some implementations, the system automatically associates all users within the specific group or domain with the new context. A user, such as the user creating the context or a user that has permission to access and/or modify the context, may change the set of resources associated with a given context, the set of users associated with the given context, and/or cause the system to determine the time associated with the given context. In some implementations, the system automatically determines a priority level or a time associated with the new contextual collaboration. As discussed above, the time may be a time of creation, time of last update, and/or time of expiration/termination. A specific duration and/or expiration time may be associated with the context where the context is a fixed-term context. In contrast, the context may have an infinite/unlimited duration such that the context does not have an expiration.

For each resource associated with a given context, the system may capture and/or manage metadata associated with the each resource. The metadata may include the size of a file, format of a file, creator of a file, character set, encoding, endianness, and the like. The metadata may include structural metadata, such as a description of how components of the object are organized or the structure of a database object such as a table, column, key, or index. The metadata may include guide metadata, such as a set of keywords in a natural language to help users find specific items (e.g., technical metadata, internal metadata, business metadata, and external metadata); process metadata; descriptive metadata (for example, information used to search and locate an object such as title, author, subject, keyword, publisher, or the like); and/or administrative metadata (e.g., technical information such as file type, rights management metadata, and preservation metadata).

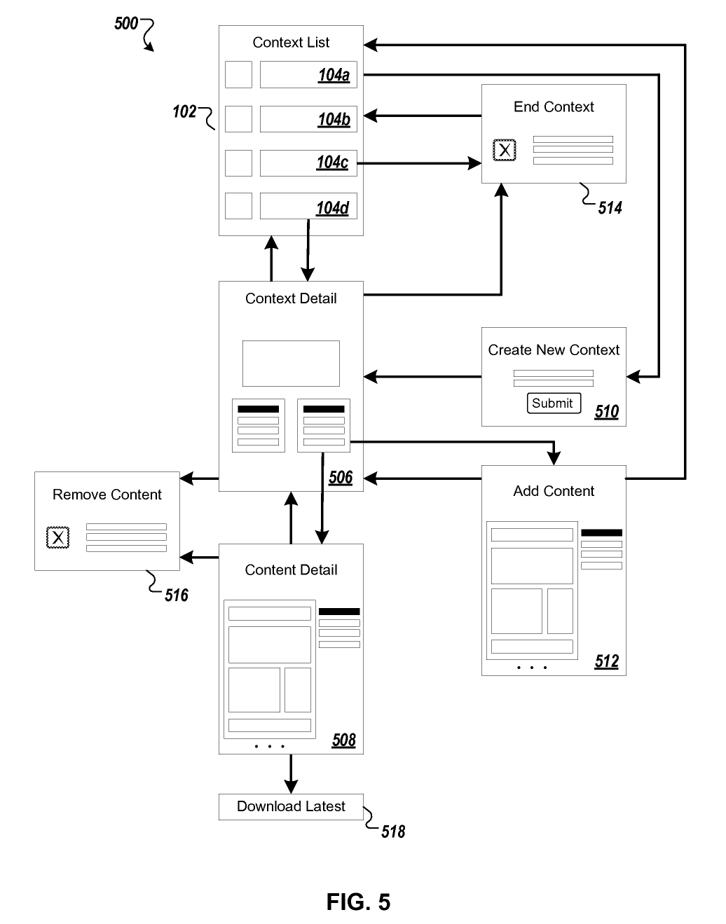

FIG. 5 is a block diagram 500 of a business workflow model for an enterprise. The disclosed technology includes an enterprise system that provides contextual graphs (e.g., contextual collaboration) that relate “resources” that occur in business workflows. The graph structure relates resources into contextual collaborations and places the contextual collaborations on a list 102, for example, based on time or priority level. To this end, at any point in time, a user of the system can view the timeline or priority level to readily identify contextual collaborations 104 (and therefore what resources within those contexts) of activities or projects that they are working on.

When a user views a context list 102, they are able to access the resources assigned to a contextual collaboration 104 in the context list 102. Examples of resources include one or more persons, documents, locations (e.g., rooms, buildings), devices, assignments, printers, presentation hardware, computers, display monitors, tasks, calendars, documents, multimedia files (e.g., videos), graphics, and audio files.

For example, a user may select a contextual collaboration 104d and view context details 506 associated with that context. A contextual collaboration 104 could be, for example, a meeting that has contents 508 associated with it. The context detail 506 provides a user with relationships or links to the associated content, such as the attendees of the meeting, the documents to be presented in the meeting, devices (projectors or displays) that the meeting will use, the location(s) of the meeting and/or the scheduled time. The user may view and download 518 details regarding the content 508 associated with any context 104 on their context list 102.

Users may wish to add a contextual collaboration 510 to or remove a contextual collaboration 514 from a context list 102. In some implementations, the system automatically updates the context list 102 when contextual collaborations are added or removed from a context list 102. Similarly, in some implementations, the system automatically updates the contextual collaboration 506 and/or the context list 102 when content is added or removed from a context detail 506 when the users add a content 512 or remove a content 516 associated with a context detail 506.

FIG. 6 is a block diagram that illustrates a system for enterprise management using contextual graphs. Users may access an enterprise system 602 via a network 604 from a computing device 606a-c. In some implementations, the computing device 606a-c is configured with a client application that allows the user to access all the available features and functions provided by the enterprise system 602. The enterprise system 602 includes one or more processors for controlling the functionality of the enterprise system 602. A computing device may embody various forms of computing devices, such as desktop computers, laptops, workstations, personal digital assistants, cellular telephones, smart-phones, tablets, and other similar computing devices. The network 604 may be the internet, an intra-enterprise network, and/or other similar networks, or a combination thereof.

A user may provide login information to the enterprise system 602 using a computing device 606 to gain access to the system. In some implementations, an authenticity module 620 authenticates the login information associated with the user. The authenticity module 620, in such implementations, compares the login information to credential data 632 stored in a data store 630 (e.g., one or more memory devices attached to and/or in communication with the enterprise system 602). The information provided by the user and/or the credential data 632 includes, for example, a username, password, name, address, phone number, age, security question information, date of birth, place of birth, identification number, social security number, telephone number, email address, passport number, company name, group name, business unit name, an employee identification number, biometric characteristic(s) (such as one or more fingerprints (including prints of one finger, two fingers, 3-5 fingers, 3-10 fingers, one palm, both palms), iris scan (one or both eyes), retina scan (one or both eyes), facial scan, hand geometry, odor, vein pattern, voiceprint, typing rhythm, gait, dynamic signature, static signature), or the like, or any combination thereof. Credential data 632 associated with a user, in some implementations, are provided during or subsequent to a registration process.

After a user is authenticated, the user is presented with a context list as discussed in relation to FIGS. 1 and 5. Upon starting the application, the user is prompted for login credentials, these credentials are validated against a configured AD/LDAP server (namely, an active directory and/or lightweight directory access protocol server) or internally in the case of an internally defined or system created user. In the case the user has previously signed on and they have not logged out of the system, the user is not required to go through the login procedure. After gaining access to the system, the user is presented with the main window of the application.

In some implementations, a contextual graph management module 628 manages the contextual lists, and a context management module 626 manages each of the contexts. The context management module 626 and contextual graph management module 628, in such implementations, work together to create and update a business workflow model (e.g., a contextual graph) for an enterprise. The modules described herein may be separate modules, combined into a single module, or any number of modules. A context list may be created for each user associated with the enterprise (e.g., employees of the enterprise, guests of the enterprise, administrators of the enterprise, etc.). Each context list is tailored to a specific user or group of users and contains one or more contexts. When a user views a context list, they will be able to access the resources assigned to a context in the context list.

In some implementations, after a user is authenticated, the user requests to authorize another user for guest access to a set of system resources. The guest user may already be a registered user or may be a new user to the system. A guest management module 622, in some implementations, controls guest access to the system, including authorizing the guest user to access the requested resources or a subset of the requested resources. The authorization, in some implementations, is based on specific name of the user or a domain identifier associated with an organization to which the user is a member.

For example, an enterprise may maintain a system as described in the present application. A user of the system may be an employee of the enterprise. The employee may request that another user receive guest access to the system. The other user may not be an employee of the enterprise. The non-employee could be a contract worker, friend, family member, business associate, or have some other similar relationship with the employee. For example, an employee may wish to register a spouse as a guest so the spouse can access information on the system relevant to health benefits. The employee may also request to provide guest access to a contract worker so that the contract worker can perform his/her required duties. In each case, the access may be preset and/or is configurable by, in this example, the employee so that the guest can access the appropriate system resources.

The system may allow a guest user to submit requests for access to a set of resources by another guest user. In some implementations, guest users are not permitted to request access to the system by another guest user. For example, only users registered with the system are permitted to submit requests to authorize users for guest access to the system. In some implementations, the system permits a guest user to request a second guest user. This may be limited to situations when the second guest user has been previously registered with the system or when the second guest user meets a predetermined qualification (for example, if the guests are coworkers).

The system receives a set of credentials associated with the new guest user. In some implementations, the set of credentials are stored in the credential data 632 in the data store 630. The set of credentials associated with the guest user, in some implementations, are provided by a user, the guest user, or by both a user and the guest user. For example, the user may provide one credential of the set of credentials and the guest user provide another credential of the set of credentials. The set of credentials and/or other information associated with the guest user may be stored for future use.

In some implementations, the guest management module 622 verifies that the second set of credentials associated with the second user meet one or more predetermined criteria for guest-level access to the system. For example, the guest management module 522 may verify that the second user is not prohibited from accessing a system resource that would otherwise be accessible based on the set of credentials. In some implementations, this is accomplished by verifying the user is not on a no-access list.

In some implementations, after a user is authenticated, the user has access to a set of system resources. The set of system resources, in some implementations, is stored on the data store 630 and includes resource data 634. An access management module 621, in some implementations, controls a user's access to system resources. In some implementations, the access management module 621 controls both users that are employees of the enterprise using the system and/or guest users.

For example, a user may be an employee with non-administrator employee access to system resources. When the employee logs into the system and is authenticated, the access management module 621 may limit the employee's access to system resources accessible to non-administrator employee access.

In some implementations, the type of access a user has is based on one or more permissions associated with the user. The permissions may be based on access data 336 stored in the data store 630. If the user is a guest user, the type of access may be configurable by a registered user, such as the registered user that requested access for the guest user. A user's access may be controlled or set according to an administrator-configurable policy.

In some implementations, the enterprise system 602 includes a resource management module 623. The resource management module 623, in such implementations, manages access to a particular resource. In certain implementations, the resource management module 623 ensures that only one user accesses a resource at a time. In other implementations, multiple users may access a resource at a time. In such implementations, the resource management module 623 allows multiple users to edit or alter a resource at a time and manages and tracks who is making edits when multiple users are editing a document. For example, when one user edits a document, changes that a user makes may be reflected in substantially real-time in the document. If multiple users are editing the document, the changes a user makes may be identified so that other users are aware who made the edits.

In some implementations, only one user may access a resource in a non-read-only mode. In some implementations, the resource management module 623 tracks who accesses a resource, when a resource is accessed, and any changes made to a resource. This information may be stored in the resource data 634 of the data store 630. The resource data 634 may include the resources themselves and/or information regarding the resources such as access history, information regarding changes to the resources, and other similar data.

The enterprise system 602, in some implementations, includes a notification service 624 that provides various notifications to users. In some implementations, the notification is transmitted to an account associated with a user, such as through a user via email, text message, automated phone calls/messages, or other similar means.

The notification service 624 may transmit a notification to a system administrator that the system received the request from a user to authorize a user for guest access to the system. The system administrator may be notified anytime someone tries to give any visitor access to the system. A user may receive a notification when their request to provide access to a guest user is approved and/or when their guest accesses a resource. In some implementations, a user may receive a notification when a guest attempts to access a resource that they don't have permission to access.

### Contextual Collaboration Workspace

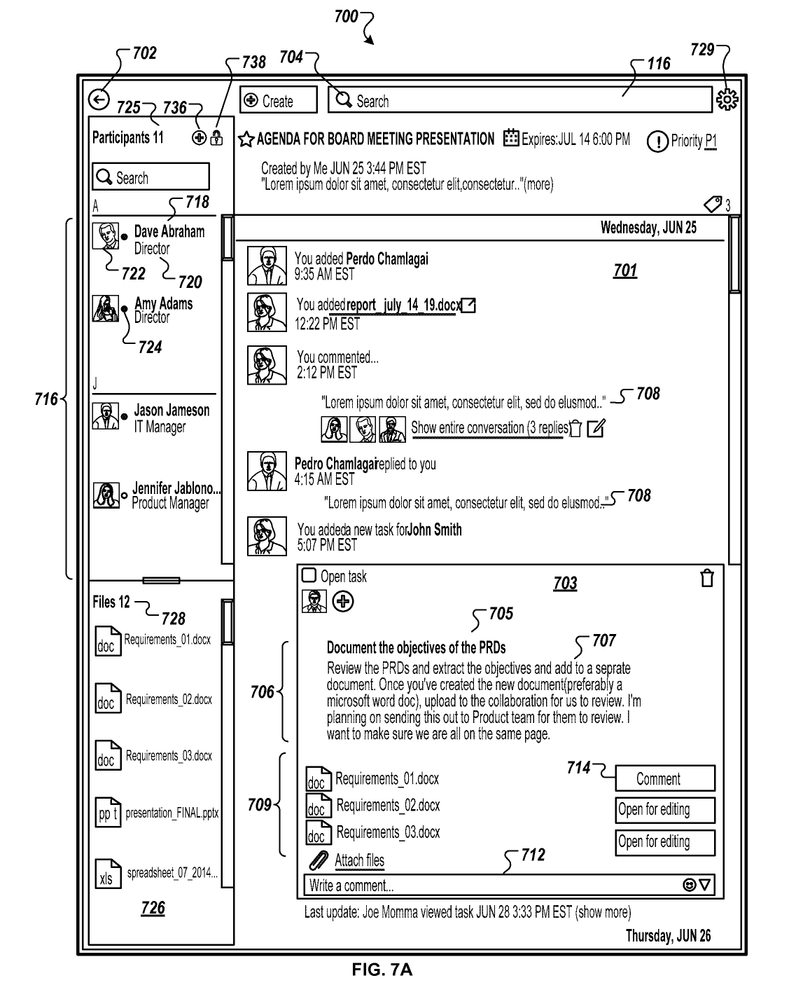

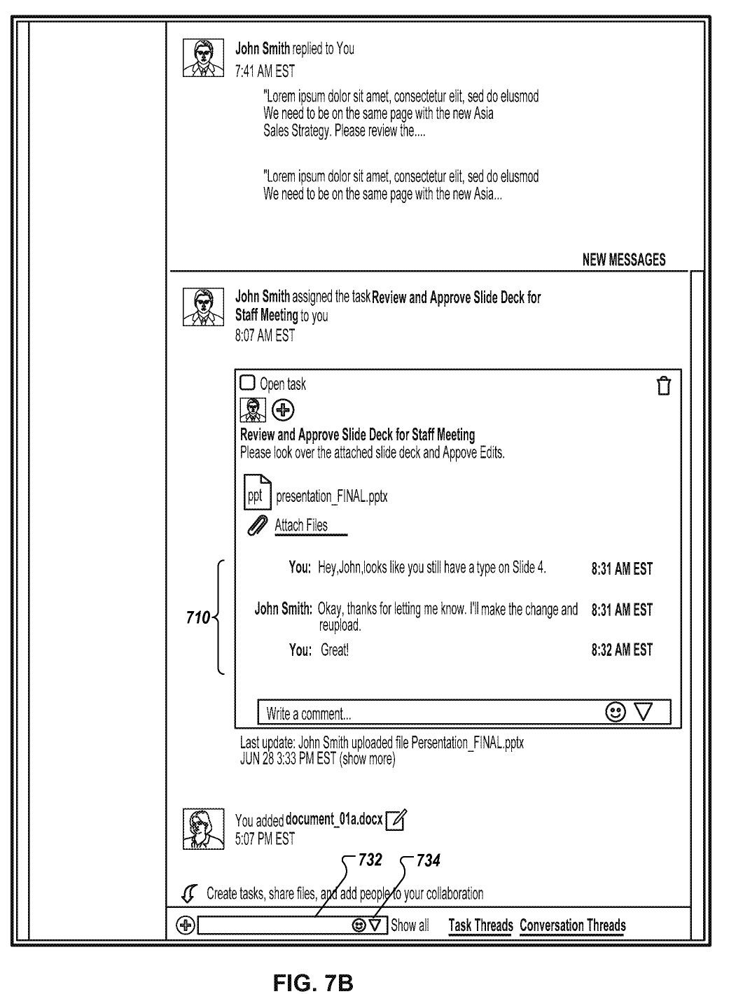

FIGS. 7A and 7B are screenshots of exemplary graphical user interfaces for viewing a contextual collaboration workspace 700. The contextual collaboration workspace 700 may also be referred to as a detailed collaboration window. Actions associated with a contextual collaboration can be performed from within the contextual collaboration workspace 700. The contextual collaboration workspace 700, in some implementations, graphically indicates, for a given contextual collaboration, the users, documents, and files, and various data associated with the given contextual collaboration.

The main portion of the workspace 700 is a main workspace 701. The main workspace 701, in some implementations, is graphically presented to include comments, tasks, conversations, file renderings, and various information for a given contextual collaboration that is available to the user. In some embodiments, the main workspace 701 graphically indicates important activity, list of users, list of files, and control inputs (e.g., a text box) for creating conversations, tasks, and approval requests.

The workspace 701 may be filtered based on tasks, conversation threads, or it may also be searched. The user can filter, in some implementations, the user list or the file list. For example, by selecting “John Smith” from the user list, the activity list shows only items related to John Smith. By selecting “John Smith” plus “asia_sales.docx” from the file list, the activity list shows only items related to John Smith and asia_sales.docx.

When the user performs these click-to-filter actions, a search term corresponding to the selected item is added to the search box. In other words, selecting user “John Smith” from the user list is the same as entering “John Smith” into the search box, so the search box displays the text, “John Smith”, entered into it. The user may subsequently enter additional search terms. For example, the user can search for “John Smith” and “asia_sales.docx” and then filter the list by keyword (perhaps searching for a phrase used in a conversation between them and another user). As shown, FIGS. 7A and 7B are screenshots of a complete contextual collaboration workspace that is not filtered.

Sub-workspace 703 shows operation of tasks. In some implementations, the task is comprised of a title 705 and associated instructions 707. Files 709 may also be included as part of the task and may be edited within the task. The user may create a task and add files to the task to which participants assigned the task (or associated with the contextual collaboration) are able to open for editing, as shown in sub-workspace 703.

The interface, in some implementations, allows for conversations within a contextual collaboration to be aimed (i) at a specific participant, (ii) at a set of Participants, or (iii) to all users in collaboration participant list. As shown in FIG. 7B, adding a comment to the text box 732 at the bottom of the collaboration detail window and pressing “Enter” sends a comment to the specified participants. The participant sending the comment can select participants from the collaboration participant list. The list may be selected from widget 734. If no participant is selected, the comment is presented to all users associated with the contextual collaboration. If the comment is directed at a specific participant or group of participants, only those participants can see the comment.

In some implementations, the list of users associated with a contextual collaboration is graphically rendered in a participant list 716. Participant list is also referred to as a user list. The participant list 716, in some implementations, includes a name identifier 718 of the user, a title 720, an associated organization 722 (not shown), and a number of users 724 associated with the contextual collaboration. The user may have a photo or icon 722 and a presence status indicator 724 associated with the user. The presence status indicator 725 may indicate presence status, such as “available”, “busy”, or “away,” though other presence statuses may be provided. A user, by default, is present when signed into the system.

The participant list may include an “Add User” widget 736 and “Add-User lock” widget 738.

In some implementations, the files and document are graphically rendered in a file list 726. The file list 726 may indicate a number 728 of files associated with the contextual collaboration.

The contextual collaboration workspace 700 may be accessed from the context list 102 when a user selects a contextual collaboration 104 to which the detailed window 700 is associated. The contextual collaboration workspace 700, in some implementations, includes one or more widgets 702 that allows the user to navigate back to, or between, the collaboration detailed window 700 and the context list 102.

As shown in FIG. 7A, the contextual collaboration workspace includes a search bar 116 (e.g., at the top of the contextual collaboration workspace 700) to allow the user to search for a specific contextual collaboration 104. Entering text in the search bar 116 and pressing enter (or clicking the search widget 704) initiates a metadata search on all available contextual collaborations for the entered keywords.

### Comments—Contextual Collaboration/File

As shown in FIG. 7A, comments from a user may be attached to a contextual collaboration or file. Comments are viewable by users that have access to the specific files or collaboration. In some implementations, a comment is a static text string associated with either a file or a collaboration. Comments include metadata (e.g., creator, creation date\time, last update date and/or time) and, in some implementations, are assigned to a specific user or group of users. In some implementations, the system allows comments to be linked to another file or contextual collaboration as a reference point.

In some implementations, the system allows a user to add comments when creating, uploading or viewing a contextual collaboration or file. A user, in some implementations, can add a comment to an active contextual collaboration or file, at any time, of which the user has access and/or permission. In some implementations, the system allows a user to add a comment when uploading a file to the contextual collaboration. In some implementations, the system allows a user to add comments to a contextual collaboration when creating the contextual collaboration.

In some implementations, comments are added as (i) a global comment, (ii) a collaboration comment, and (iii) a comment attached to a file. Comment attached to a file (or file series), in some implementations, are added only by the collaboration owner or the file owner when the file is added to the contextual collaboration. Comments are viewable by only users that have access to the file.

In some implementations, the comments 706 are added by the user via an input field 712 (e.g., located next to the attached files). Collaboration comments 708, in some implementations, are attached to a contextual collaboration. This type of comments is viewable by users that have access to the contextual collaboration. File comments 710 (see FIG. 7B), in some implementations, are added by users associated with the contextual collaboration and are viewable by users that have access to the contextual collaboration. File comments 710 are added, in some implementations, via a comment widget 714.

### Permissions—Contextual Collaboration

Contextual collaborations have an associated set of values that dictate permissions and ownership of the contextual collaboration and other collaboration specific variables. In some implementations, the collaboration owners access a collaboration-preference window to change such settings. The collaboration-preference window, in some implementations, is accessed when the user clicks on the preference window widget 729 (as shown, for example, in FIG. 7A).

In some implementations, the collaboration-preference window is graphically rendered as a dialogue box in which options are presented as radial buttons, toggles, drop-down options. Other methods of selecting permissions known in the art may be employed.

Collaboration permissions allow a collaboration owner to set permissions for the contextual collaboration. The permissions may be applied as a whole to restrict or allow different capabilities for users for a given contextual collaboration. Table 1 lists an exemplary collaboration access level for users. Certain options are only configurable by the collaboration owner.

TABLE 1
Example Collaboration Access Level

| | Configurable | Default User |
|---|---|---|
| Collaboration Option | by Owner | Settings |
| Change Name | Y | Not Allowed |
| Set\Clear Expiration Date | N | N/A |
| Delete Collaboration | N | N/A |
| View Collection | N | Not Allowed |
| Add\Remove Owners | N | N/A |
| Lock Files | N | N/A |
| Lock Owners | N | N/A |
| Lock Users | N | N/A |
| Add Files | Y | Allowed |
| Remove Any Files | Y | Not Allowed |
| Remove My Files | Y | Allowed |
| Allow File Downloads | Y | Not Allowed |
| Add User | Y | Not Allowed |
| Remove User | Y | Not Allowed |
| Add External User | Y | Not Allowed |
| Remove External User | Y | Not Allowed |
| Add Tasks | Y | Allowed |
| Add Comments | Y | Allowed |
| Set System Priority | Y | Not Allowed |

In some implementations, collaboration management items are accessible to only the collaboration owner. These management items may include: changing the name of the Collaboration; allowing the owner(s) to set an expiration date or clear the expiration date in which the Collaboration never expires. Collaboration owners may delete the contextual collaboration or cause its premature expiration if desired.

Collaboration owners may add or remove other owners, though these added owners cannot modify permissions of other owners. “Lock user” is a setting to block the addition or deletion of owners and users to the contextual collaboration.

The collaboration owner may prevent the ability for participants to add other participants by locking the participant list. When this happens, the controls in the UI that enable adding participants will no longer be visible to the participants. The owner may also unlock the ability for other participants to add participants at any time.

The owner may remove the ability for participants to add files by locking the documents list in a contextual collaboration. When this happens, in some implementations, the controls in the UI that enable adding files will no longer be visible to the participants. However, the owner always has the ability to add documents, but only after removing the locked status from the document list—this approach is taken to ensure the owner and participants have a consistent view. The owner may enable participants to add documents at any time by unlocking the document list. A notification is sent to all participants informing them of the change.

“Lock Files” is a setting to block the addition and/or deletion of files to the contextual collaboration. In some implementations, the “lock files” setting applies to both owners and users—though owners have the option of removing the setting.

“Lock Owners” is a setting to block the addition and/or deletion of collaboration owners to a given contextual collaboration. In some implementations, the “lock owners” setting applies to only to collaboration owners that are not the creator of the contextual collaboration.

“View Collection” creates a global contextual collaboration in that users within the organization or domain of the collaboration owner have access.

File Handling options (e.g., add files, remove any files, remove my files, and allow file downloads) are configured by owners, and applied to users. “Add files” allow or prevent users from uploading files to the contextual collaboration. The default setting for this permission is “allowed.” “Remove My Files” allow or prevent users from removing files that they have added to the contextual collaboration. The default setting for this permission is “allowed.” The “Remove My Files” setting takes precedence over “Remove Any Files” setting. “Allow File Downloads” allow or prevent users from downloading files from the contextual collaboration, though the file can be previewed. The default setting for this permission is “allowed.” “Add Users” and “Delete Users” grant users the ability, or prohibit them, to add and delete, respectively, other users to the contextual collaboration. The default setting for this permission is “not allowed.”

“Add External Users” and “Delete External Users” grant users the ability, or prohibits them, to add or delete, respectively, external users of the contextual collaboration. The default setting for this permission is “not allowed.”

“Add Comments” grants users the ability, or prohibit them, to add collaboration-specific comments. The default setting for this permission is “allowed.” “Add Tasks” grants users the ability, or prohibits them, to add tasks to a contextual collaboration. The default setting for this permission is “allowed.”

“Set System Priority” grants the user the ability, or prohibits them, to set the system priority of the Collaboration. The default setting for this permission is “not allowed.”

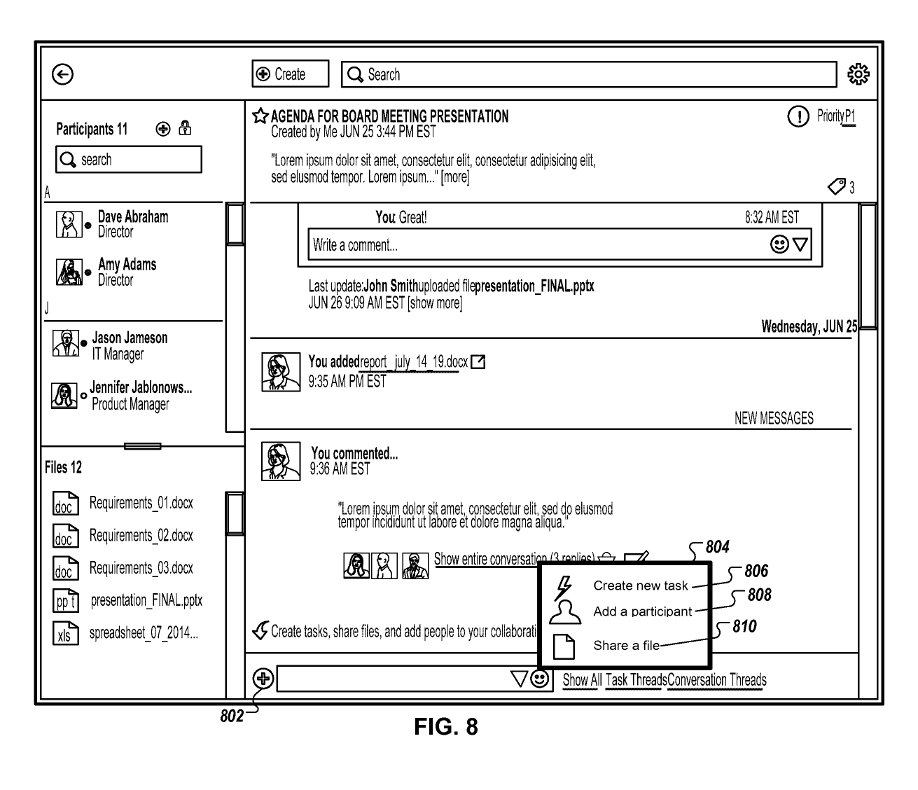

FIG. 8 is a screenshot of another exemplary graphical user interface of a contextual collaboration workspace. As shown in FIG. 8 (and FIG. 7B), in some implementations, each contextual collaboration workspace 700 includes an add button 802 to add files, participants, and tasks to a contextual collaboration. The add button 802 may be located next to the add comment text box 732. In some implementations, upon clicking on the add button 802, the system presents a dialogue box 804 with options to add a new task (806), to add a participant (808), and share a file (810). The system then initiates the corresponding work flow upon a selection received by the user.

In some implementations, selecting the “Share a File” option 810 opens a file browser window and allows the user to select a file to upload to the contextual collaboration. Alternatively, or in addition to, the system, in some implementations, allows files to be added by being dragged and dropped over the “Files” section of the collaboration detail window.

In some implementations, selecting the “Add a Participant” option 808 opens a list of available participants that a user can add to the contextual collaboration. The user may select one or more participants from the available list.

In some implementations, selecting the “Create new Task” option 806 opens a list of available options, for example: assign task to a specific user, add task to a specific group, request an upload of a file, request a comment on a file, request a response of another user's feedback on a file, among others. When a new task is assigned, in some implementations, the user is notified in the context list 102 and also in the activity feed within the contextual collaboration workspace 700. When creating a task request, the creator can set an optional priority level or deadline, or both. If a task is created, it is visible to the recipient in the context list 102 and also in the activity feed within the contextual collaboration workspace 700.

Tasks are viewable by all users associated with the contextual collaboration. Tasks are assignable to a user or group of users and are assigned a status state selected from a pre-defined set of status states (namely, status such as opened, closed, or completed). The status states are set, in some implementations, by the user that created the task.

Tasks can be added to files or to a contextual collaboration. Tasks can be assigned by a user with the appropriate permissions and can be directed at any other user(s) in the contextual collaboration. A task consists of the actual text of the comment and associated metadata (e.g., creator, creation date and/or time, last update date and/or time, list of users to whom the action was assigned, text of the task, and task status).

An approval request is a specific kind of action assignment. The approval request allows a user to prompt another user to approve a document and create a record of the approval for later reference. To create an approval request, in some implementation, the creator of the request selects one or more approvers from the participant list and one or more documents from the document list. The system then sends the approval user a notification (in the contextual list of that approval user and also the contextual collaboration workspace of that approval user) that an approval request has posted. When approving a file, the system presents to the approval user, selectable options from a pre-defined list, including, for example, but not limited to: “Approved” and “Not Approved.” In some implementations, the system further presents to the approval user with an option to leave comments as to why the file is not approved. The comments may be presented in the context list 102 of only the user that initiated the request or to all users associated with the contextual collaboration.

### Live Share Sessions

Participants (i.e., users) of a contextual collaboration may initiate a Live Share session directly from the contextual collaboration. When initiating a Live Share session, the initiator of the Live Share session can either select participants from the participant list or, if no participants are selected, all participants are included. Clicking the “Live Share” button sends an indication to all relevant users that they have been invited to a Live Share session; they can accept or decline. If accepted, the current view of that user changes to display the Live Share workspace.

During the Live Share session or when initiating the session, the initiator of the Live Share can select any document from the list available in the contextual collaboration to share with the other participants. Users may also send comments to the Live Share participants by writing the comment in a comment box (e.g., located at the bottom of the Live Share session). To end a Live Share session or exit from the session, the user selects the “End Live Share” widget provided within the Live Share workspace. Once completed, a record of the Live Share is stored in the contextual collaboration for reference. The contents of the Live Share can be collapsed within the contextual-collaboration workspace.

### Files

Files (also referred to as documents) are resources uploaded by a user directly or via adding them to a contextual collaboration. In some implementations, files, once shared, are viewed, modified or downloaded by other users/owners of the contextual collaboration based on permissions associated with the files. In some implementations, users upload files to a private store to which access is limited only to them until the files are shared.

In some implementations, the system allows for the managing of access of file series. File series (DS) are part of a set of files, of different one or more versions of the file. When the original document is downloaded by a participant in the context to review and edit and then uploaded into the system. A single file may be referred to as a file series. The system allows users to update files owned by incrementing in the series.

In some implementations, when a user uploads a file to either a contextual collaboration or to a private file store to which they are the sole owner of the file. Sharing the file is at the discretion of the user. Each user may upload files to the network system and these are stored as assets belonging to that specific user.

In some implementations, users have access to a variety of files, with some of these files, they are the owner and other files they have access to via a contextual collaboration. The system, in some implementations, sorts the files available to the user into two different categories, owned and shared. An owned file provides the user with all rights and privileges related to the file. Namely, they can share, set permissions, and delete the file. Shared files available to the user are owned by a different user and therefore are restricted based on permissions provided by the document owner.

In some implementations, files may be shared by adding them to a contextual collaboration and adding users to that collaboration. Based on the collaboration permissions, the users may have access to download the file.

In some implementations, sharing a file with other users, in some implementations, include: create a contextual collaboration, add files, and invite users.

To restrict access to sensitive files, there are access levels and permissions that relate specifically to a file or file series. These settings may override the collaboration level permissions. The user can assign specific settings to these files to enable\disable various actions that can be performed pertaining to these files. Table 2 displays exemplary permissions for modifying file options for a file series. Table 3 displays exemplary permissions for modifying file options for a contextual collaboration.

TABLE 2
File Options for Files Series

| | Configurable | Default User |
|---|---|---|
| File Option | for Users | Settings |
| Change Name | N | N/A |
| Expire | N | N/A |
| Archive | N | N/A |
| Delete | N | N/A |
| Add\Remove Owners | N | N/A |
| Set Access Level | N | N/A |
| Add\Remove | N | N/A |
| Named Users | | |

TABLE 3
File Options on Files in Collaboration

| | Configurable | Default User |
|---|---|---|
| File Option | for Users | Settings |
| Add Comments | Y | Allowed |
| Add Tasks | Y | Allowed |
| Allow Download | Y | Allowed |
| Allow Sharing | Y | Allowed |

In some implementations, there are four file access levels that can be assigned to a file. File access levels include, in some implementations, named users, domain user access, NDA only access, and public access.

“Named user” access restricts file access to only those users that have been named by the owner regardless which collaborations the files may reside. If a file with a named user access level is available in a collaboration, the named users to this specific files are allowed access (e.g., to view, share, or download).

In some implementations, a named user cannot change access levels or permissions on a file. In some implementations, the file owner or named user can place the file into any collaboration to which they are an owner or user with the appropriate permissions, however, only the people who are named users or file owners can see the file inside of the context view. A named user is independent of the other three access levels, and the file owner(s) must explicitly set this access level.

A file with domain user access is only visible to users who are members of the system domain—e.g., have the same email domain. A user with access to a file with this access level is allowed access to view, download, share this file as permissions allow. The file owner(s) must explicitly set this access level.

“NDA only” access restricts files to users within the system domain (Domain User Access) as well as Non-Users (external Participants) who have entered into an appropriate agreement with the company (for example a consultant).

When adding a file of this type to a contextual collaboration (and there are presently non-users added to the collaboration), the system prompts the user with: “The File access level is “NDA Only Access,” and there are Non Domain Users included in this Collaboration. Proceed?”

The user must affirm to the question to add the file to the collaboration. If the user declines, the operation is aborted. In some embodiments, if a contextual collaboration contains a file with “NDA-only” access and a non-user is added to the contextual collaboration, the system prompts with: “The Collaboration contains File(s) with access levels set to “NDA Only Access” adding Non Domain Users requires NDAs. Proceed?” The user must affirm to the question to add the non-user to the contextual collaboration. If the user declines, the operation is aborted. The file owner(s) must explicitly set this access level for a given file.

“Public Access” is the default access level given to any files added to the system. Files with this access level have no restrictions and fall under collaboration permissions.

Permissions may be applied to files to allow or prevent access and actions on the files. Permissions can only be applied by file owners and permissions vary depending on the access level of the files. Owners have access to all functions pertaining to files regardless of the permission settings.

### File Handling

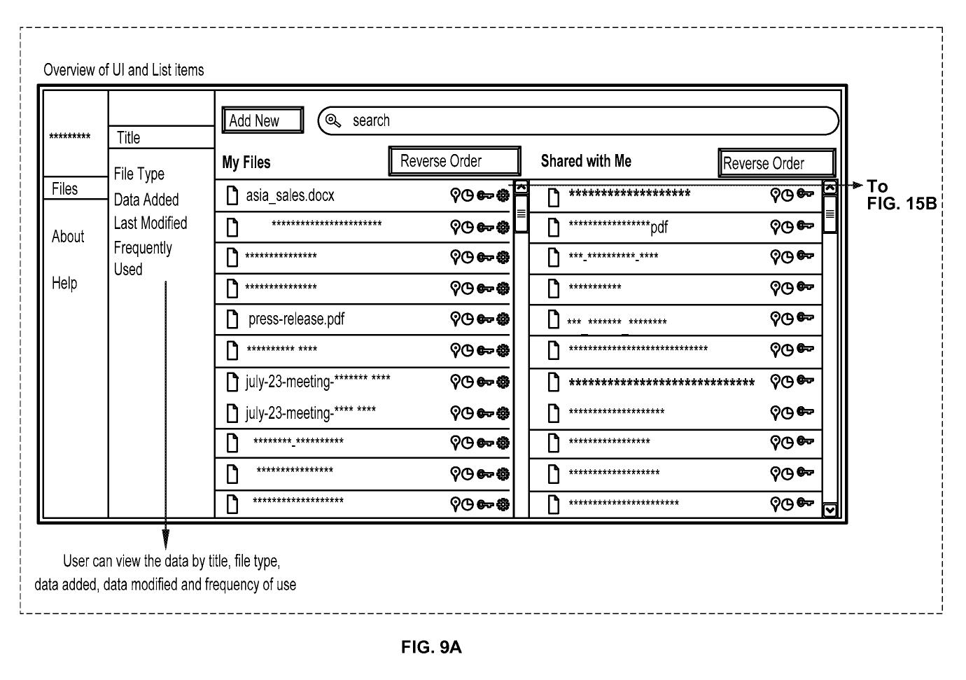

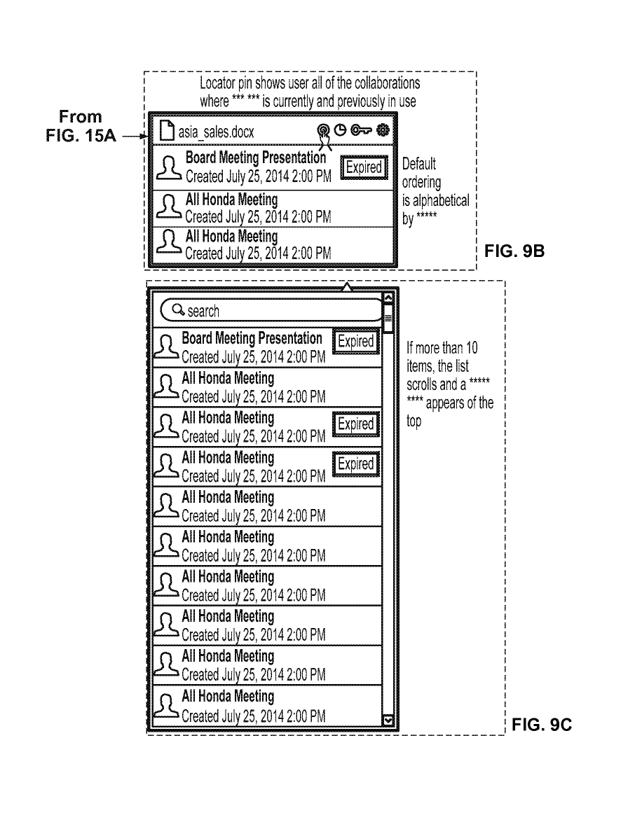

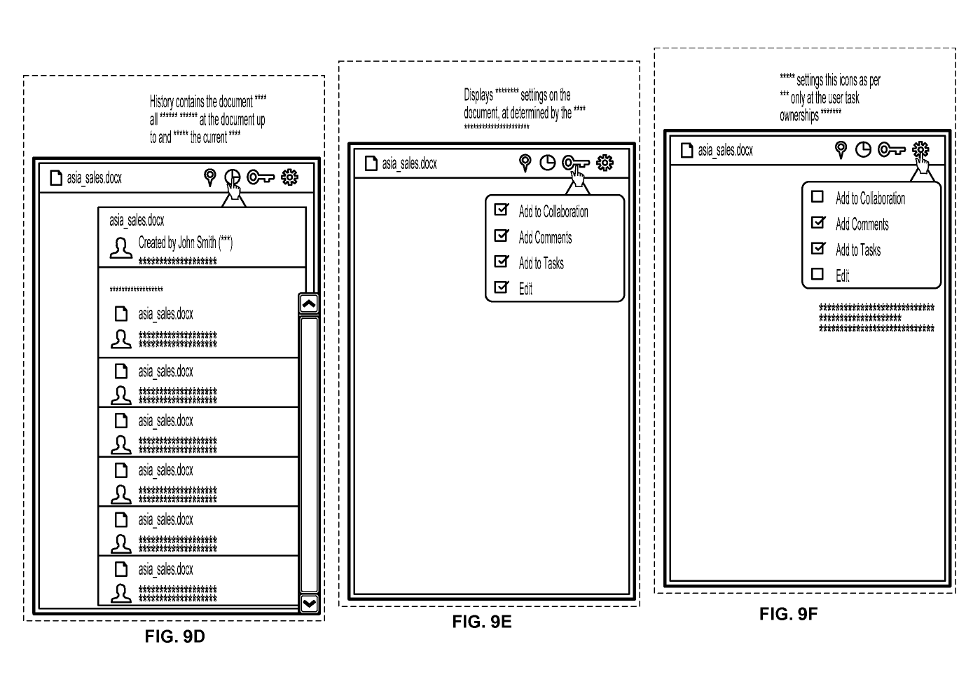

FIGS. 9A through 9F are screenshots of an exemplary graphical user interface for handling files associated with a plurality of contextual collaborations. A user may upload files to a personal storage location (PSL) without having to upload them to a contextual collaboration. There are two types of personal storage locations: owned files and shared files. Owned files are files uploaded by the user that is the owner of the files. Shared files are files that have been shared with the user via a contextual collaboration.

A user may access files from the PSL to upload to a contextual collaboration. In some embodiments, the users are able to set permissions for their owned files from the PSL. Shared files are removed from the list if the owner of the source contextual collaboration, for example, removes the user from the contextual collaboration; applies permissions to the files which cause the share to be revoked; or archives the contextual collaboration.

Creating Contextual Collaboration from Operating System

FIG. 11 is a screenshot of an exemplary graphical user interface for creating a contextual collaboration from a windows application. The context menu 1102 allows the user to add a file directly to system via right-clicking on a file and selecting the appropriate option. This option is shown for a Windows Operating System environment 1104. Right-clicking the desired file and selecting the menu item allows the user to create collaboration (1106) or add file to a collaboration (1108). The “create collaboration” option 1106 initiates the process of creating a new collaboration with the file as a new file series and the user as the owner of both the collaboration and the file series.

The “add to collaboration” option 1108 allows the user to add the file as a new file series to an existing contextual collaboration that they have access to (and permission to add files as well in case they are not the owner) to which the user is the assigned as the file owner.

Creating Contextual Collaboration from Email

FIG. 12 is a screenshot of an exemplary graphical user interface for creating a contextual collaboration from an electronic mail (email). In some implementations, collaborations are directly created from an email in which email messages are assigned as items within a contextual collaboration. This feature allows a user to copy an email into system and create a new contextual collaboration directly from that email. In some implementations, a user can add an email as a new contextual collaboration by dragging the email message from a mail client.

In some implementations, when creating contextual collaboration from an electronic mail, the system assigns the addressor 1204 and the one or more addressee 1206 as users for a new contextual collaboration. In some implementations, any accounts that match an email address recognized by the system are added to the contextual collaboration. In some implementations, the “BCC” field recipients are not added to the collaboration. The email subject 1208 may be assigned as a name of the added contextual collaboration. The email body 1210 may be assigned as a comment within the contextual collaboration. The attachments 1212 (not shown) may be assigned as files of the contextual collaboration.

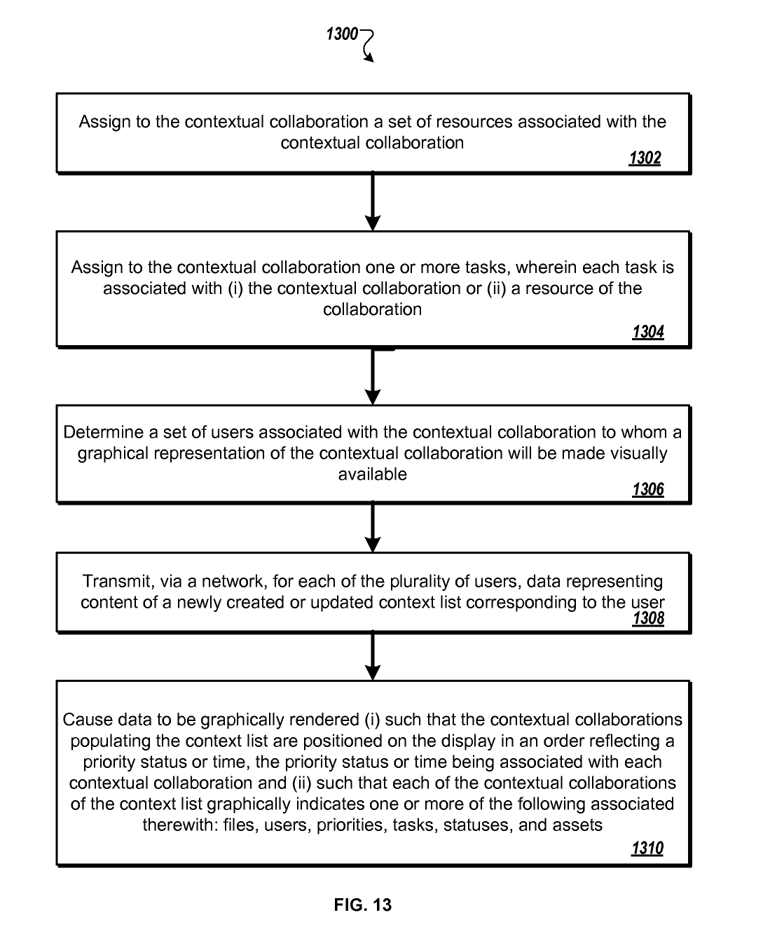

FIG. 13 is a flowchart illustrating a method 1300 for creating a collection of contextual collaborations for users associated with an enterprise. The method 1300 includes creating, by a processor of a computing device (e.g., a server), for each of a plurality of users associated with the enterprise (e.g., employees of the enterprise, guests of the enterprise, administrators of the enterprise, etc.), a context list of a plurality of contextual collaborations specific to the user. The steps of creating the context lists include for each of the plurality of contextual collaborations assigning to the contextual collaboration a set of resources (e.g., files and assets) associated with the contextual collaboration (step 1302). The assigning may allow nesting of contextual collaborations within other collaborations. The set of resources has been received from one or more of the plurality of users.

The step of creating the context lists also includes assigning to the contextual collaboration one or more tasks, wherein each task is associated with (i) the contextual collaboration or (ii) a resource of the collaboration (step 1304). Each task may include an associated originator of the task, a due date, and a task completion status. Each of the one or more tasks has been received from one of the plurality of users.

The method 1300 also includes determining a set of users associated with the contextual collaboration to whom a graphical representation of the contextual collaboration will be made visually available (step 1306).

The method 1300 then includes transmitting, via a network, for each of the plurality of users, data representing content of a newly created or updated context list corresponding to the user (step 1308).

The method 1300 then includes causing the data to be graphically rendered, on a display of a computing device associated with a given user (step 1310). The context list, in some implementations, is graphically rendered (i) such that the contextual collaborations populating the context list are positioned on the display in an order reflecting a priority status or time, the priority status or time being associated with each contextual collaboration and (ii) such that each of the contextual collaborations of the context list graphically indicates one or more of the following associated therewith: files, users, priorities, tasks, statuses, and assets. In some implementations, the data is graphically positioned top-to-bottom in sequential order according to time of creation, time of last update, time of expiration of the contextual collaboration, assigned priority value associated with the contextual collaboration, assigned priority value associated with a resource within the collaboration.

### “Visitor Pass” Access to Software and Services

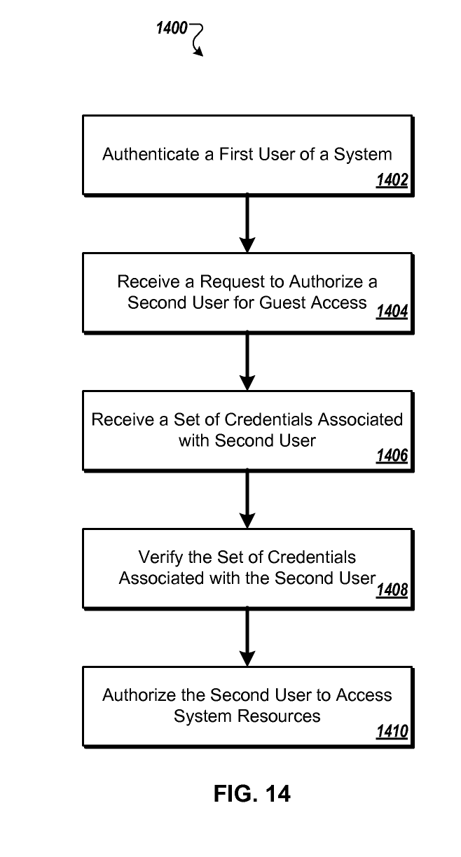

FIG. 14 illustrates an example method 400 for enterprise management and access control. In some implementations, users may register with the system as described in the present application by creating a user name and password. The user may provide various information when registering including, but not limited to, a username, password, name, address, phone number, age, security question information, date of birth, place of birth, identification number, social security number, telephone number, email address, passport number, company name, group name, business unit name, an employee identification number, biometric characteristic(s) (such as one or more fingerprints (including prints of one finger, two fingers, 1-5 fingers, 1-10 fingers, one palm, both palms), iris scan (one or both eyes), retina scan (one or both eyes), facial scan, hand geometry, odor, vein pattern, voiceprint, typing rhythm, gait, dynamic signature, static signature), or any combination thereof. The information may include any other suitable credential used for identification of individuals.

The credential data may be provided during or subsequent to the registration process. Registration may be limited to user's with certain associations with the enterprise using the system. For example, registration may be limited to employees of an enterprise associated the system. Registration may be limited to a specific subset of employees of an enterprise associated the system. During or before registration, the system may verify that the user is employed by an enterprise associated with the system.

The system may authenticate a user of the system (1402). The authentication may be performed by analyzing input provided by the user. The system may determine that the input matches a set of credentials associated with the user. The set of credentials may be based on information provided by the user during, or subsequent to, the registration process.

After authentication, the user may be registered with the system and have authorization to access a set of system resources according to a predetermined access level. The set of system resources includes one or more system resources. For example, the user may be an employee with non-administrator employee access to system resources. When the employee logs into the system and is authenticated, the system may limit the employee's access to system resources accessible to non-administrator employee access.

A user or users may request to authorize another user for guest access to the system (1404). The guest user may or may not be previously registered as a user of the system. For example, an enterprise may maintain a system as described in the present application. A user of the system may be an employee of the enterprise. The employee may request that another user receive guest access to the system. The other user may not be an employee of the enterprise. The non-employee could be a contract worker, friend, family member, business associate, or have some other similar relationship with the employee. For example, an employee may wish to register a spouse as a guest so the spouse can access information on the system relevant to health benefits. The employee may also request to provide guest access to a contract worker so that the contractor can perform his/her required duties. In each case, the access may be preset and/or is configurable by, in this example, the employee such that the guest can access the appropriate system resources.

After receiving a request to permit access to the system by a guest user, the system receives a set of credentials associated with the guest user (1406). The set of credentials associated with the guest user may be provided by a user, the guest user, or by both a user and the guest user. For example, the user may provide one credential of the set of credentials and the guest user provide another credential of the set of credentials. The set of credentials and/or other information associated with the guest user may be stored for future use.

The system verifies that the set of credentials associated with the guest user meet one or more predetermined criteria for guest-level access to the system (1408). For example, the system may verify that the guest user is not prohibited from accessing a system resource that would otherwise be accessing based on the set of credentials. In some implementations, this is accomplished by verifying the guest user is not on a no-access list.

After successfully verifying the guest's set of credentials, the system authorizes the second user to access a set of system resources (1410). The authorization may be completed without requiring intervention from another user (e.g., without intervention of an IT administrator). The system may automatically process the authorization based on a stored set of rules or criteria. If the system identifies one or more conditions that require review of the guest user's information by an administrator, the system may contact an administrator prior to completing authorization. For example, if a registered user requests that a guest user have access to a set of resources that includes company trade secrets or confidential information, the system may notify an administrator prior to providing the guest with access. The administrator may need to approve access before the system authorizes access for the guest user. For example, the administrator may need to confirm that the appropriate non-disclosure agreement is in place prior to the system authorizing the guest user to access the set of resources. In contrast, the entire authorization process may be automated and performed without the intervention of an individual such as an administrator.

A set of resources includes one or more resources. The resources available to a guest may be identified by the registered user that requested access to the system for the guest user. The set of system resources accessible to the quest user may be one or more documents and/or one or more applications. The set of system resources accessible by the guest user may be less expansive than the set of resources accessible by the registered user. In some implementations, the set of system resources accessible by the guest user may be more expansive than the set of resources accessible by the registered user. For example, the registered user may work in the human resource department of the enterprise. The registered user may be responsible for providing access to a set of resources for a contract worker (for example, a contract worker specializing in information/network technology), however, the registered user may not have access to the set of resources accessible to the contract worker. In some implementations, a registered user may only provide a guest user with access to system resources that are also accessible by the registered user.

The set of system resources accessible to the guest user may be associated with a triggering event of limited duration or lifetime. For example, the duration of the guest user's access to the system or a set of resources may be based on a time period associated with a meeting, a presentation, a project, or other similar item. The guest access to a set of system resources may be limited by the duration or lifetime of the triggering event. For example, the guest may access the set of resources only for the duration of the meeting, the presentation, the project, and/or for a predetermined time before or thereafter.

In some implementations, the system may authorize access by the guest access in substantially real time. The system may authorize the guest user for guest access to the system within a time period corresponding to substantially real time in relation to receipt by the system of the request from the user to authorize the guest user for guest access to the system.

In some implementations, the system authorizes the guest user to access the set of system resources if the registered user is authorized to permit access to the set of system resources to users not previously registered with the system and/or if access to the set of system resources is not restricted only to users registered with the system. The set of resources accessible by the guest user may be of the type that may be accessed by users not registered with the system. For example, access by the guest user to a set of resources may be denied if the set of system resources that the registered user wants to provide the guest with access to are only accessible by users registered with the system (e.g., employees). In some implementations, the set of resources accessible by the guest user does not or may not include any restricted or confidential information. For example, access to restricted or confidential information may be limited to users that are registered with the system.

Access to resources by a registered or guest user may be based on a predetermined access level. The predetermined access level may be based on a security clearance and/or employment position. For example, access may be determined by employment position—an engineer may have a different access to documents than, e.g., a receptionist.

Guest-level access to a set of resources may include read-only access to the set of resources. For example, the guest user may not be allowed to modify/delete/create a resource, such as a document. The guest-level access may permit editing of identified documents, uploading of documents, and/or sharing of documents within the system and/or outside the system. In some implementations, the documents are electronic documents. The system may authorize to guest user to access a company directory or other data available on the system. The system may authorize the guest user to operate a device such as a printer, fax machine, projector, computer, electronic lock for conference/meeting room, or the like. The system may authorize the guest user to access a computation resource, such as an offline file format conversion service.

The type of access may be based on one or more permissions associated with the guest user. The type of access may be configurable by a registered user, such as the registered user that requested access for the guest user. The guest user's level access may be controlled or set according to an administrator-configurable policy.

In some implementations, the system generates and transmits, to a computing device associated with the guest user, a temporary token associated with the guest user. Access to the token is restricted to computing devices registered with the system (e.g., company computers or computers previously registered with the system), or to computing devices running an application associated with the system, and/or with pre-approved computing devices. In some implementations, access to the system is only permitted by computing devices with a token that was provided by, or registered with, the system.

The system may transmit a notification to a system administrator that the system received the request from a user to authorize a user for guest access to the system. The system administrator may be notified anytime someone tries to give any visitor access to the system. The notification may be transmitted to an account associated with the system administrator. The notification may be added to a list of notifications accessible by one or more system administrators. In some implementations, the notification is transmitted to a system administer via email, text message, automated phone calls/messages, or other similar means.

### Cross-Enterprising Mirroring

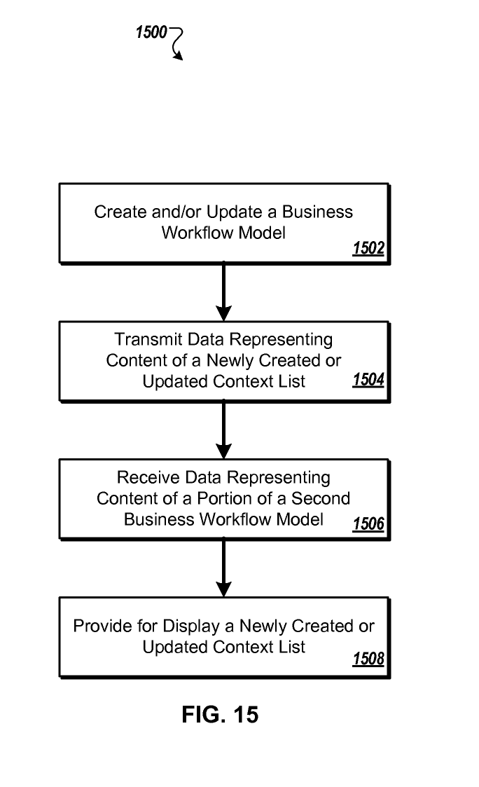

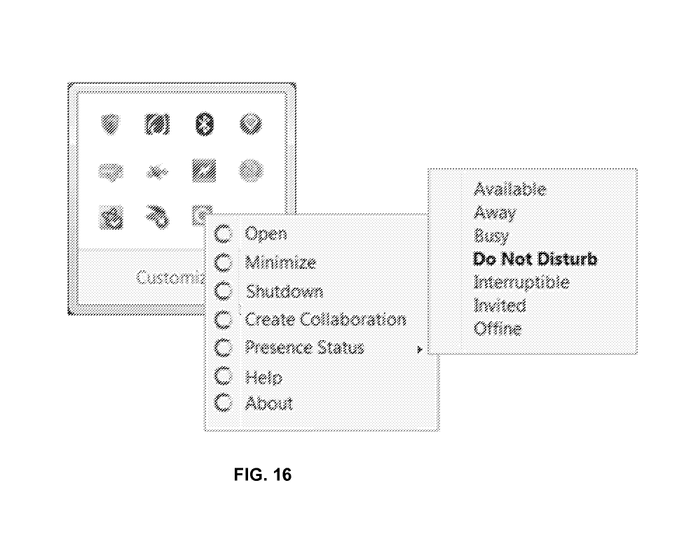

FIG. 15 is a flowchart illustrating a method 1500 for secure mirroring of business workflow models among two or more domains. The method 1500 includes creating and/or updating, by a processor of a computing device, for a first domain (e.g., company, institution, group, or business enterprise), a business workflow model (e.g., contextual graph) associated with the first domain (1502). The business workflow model includes one or more contexts and each context is associated with one or more users within the first domain. As discussed above, each of the contexts has a set of resources assigned to the context.

After creating or updating a business workflow model, data representing the content of the newly created or updated context list is transmitted to a user (1504). The data may be transmitted via a network, such as the network 104 described in relation to FIG. 3. The newly created or updated context list associated with a user may be displayed on a graphical user interface the user's computing device.

The system may receive, via the first network or a second network (e.g., intranet, or internet), by one or more users within the first domain, data representing content of a portion of a second business workflow model (e.g., contextual graph) associated with a second domain (e.g., company, institution, group, or business enterprise) (1506). In this context, the second domain is different from the first domain. The portion of the second business workflow model received by the one or more users within the first domain may be restricted to a shared subset between the first and second domains (e.g., wherein the shared subset comprises contexts and associated resources of the business workflow models/contextual graphs related to an ongoing collaboration between employees of the first and second domains).

After receiving the data representing content of a portion of a second business workflow model, the system provides a newly created or updated context list from the first business workflow model of display on the graphical user interface of a computing device of a registered user of the first domain. The newly created or updated context list may include contexts belonging to the shared subset. The first business workflow model and the second business workflow model may be created and/or updated via eventual consistency architecture and the workflow models may be part of a highly scaled web-based architecture.

The system may establish and enforce semantics for the resources within the shared subset. The semantics may include modification rules, such as logical structures whereby users of the domain that own a given shared context (e.g., where such users are associated with the shared context) are given permission to modify one or more resources and/or other detail associated with the given shared context, while users of a non-owning domain (e.g., where such users are associated with the shared context]) have permission to view the one or more resources, but not to modify them. The semantics may include sharing rules, such as logical structures whereby users of a domain that own a given shared context (e.g., where such users are associated with the shared context) are given permission to view and/or transmit one or more resources and/or other detail associated with the given shared context, and/or users of a non-owning domain (e.g., where such users are associated with the shared context) are given permission to view and/or transmit one or more resources and/or other detail associated with the given shared context.

The disclosed technology includes intelligent scoping of data from the first business workflow model and data from the second business workflow model to identify the shared subset between the first and second domains. Intelligent scoping of data associated with a plurality of business workflow models corresponding to a plurality of domains may allow the identification of a plurality of shared subsets amongst the domains.

The system may enforce access and/or use rules for a resource of the context. Each of the access and/or use rules may have both a time dependence and a situation (context detail) dependence. For example, the access and/or use rules may include permitting operation of a printer in an authorized room of an enterprise by a visitor, but only if the visitor is scheduled to attend a meeting (context) at the enterprise, as reflected by the business workflow model for the enterprise, and only for an indicated duration corresponding to the duration of the meeting. Similarly, the system may permit access to a document by participants of a context (e.g., meeting or other event) only until a selected goal is reached (e.g., completion of a project that is the context, or is associated with the context). The system may permit access to a resource only upon prompted re-authentication by the user, acknowledgment of TOC, acknowledgement of compliance obligations, and/or acceptance of IP license terms at a point of access to the resource. Examples of access and/or use rules further include a rule that no confidential document (resource) of an owner domain can be shared with a third party (e.g., domain other than the owner domain) unless that third party has signed a non-disclosure agreement with the owner domain. In the context of a meeting, a rule may designate that no meeting resource of an owner domain can be mirrored to a third party (e.g., domain other than the owner domain) if the meeting includes a named officer (e.g., CEO or CFO) of the owner domain. Rules may also be used to implement security protocols. For example, a rule may establish that resources of an owner domain must be encrypted with a domain-approved DRM scheme if they are exposed to any third party (e.g., domain other than the owner domain).

### User-Specified Graph Extension and Platform Performance Hooks

A customized graph object (e.g., software) that is operable by the set of users associated with the context (e.g., wherein the customized graph object is a program) may be assigned to a context. The customized graph object may provide tracking of metadata concerning documents that are not provided in a base document class. The customized graph object can be mirrored between domains as per built-in resources that are shared among two or more domains and/or subject to a security policy framework.

### Lease-Based Access Control

The system may also provide lease-based access control. This provides the ability to “lease” content (business docs) and revoke or expire access to content after the specified set of conditions are met. Some examples of resources include a user credential, a file resource, a web-service, and application context objects. A lease object may define the ‘terms and conditions’ that limit usage of a resource. The lease specifies usage conditions of a resource with respect to a user of the resource. A lease is activated when an issuing resource (e.g., a document owner) is ‘accepted’ by a lessee (e.g., an end user account). A lease may define broad usage conditions including conditions that result in revocation of usage such as, for example, (a) naming specific users, resources, groups, organizations or domains as potential audience, (b) limitations for number of permitted operations, (c) limitations for amount of transferable data, (d) revoke usage to a set duration after first access, (e) revoke usage after a set date, (f) revoke usage once if the state of a network resource is triggered. Access to resources can be limited by stipulations defined in the leases that expire after a preset time for example “share for 24 hours, then revoke”. Leases can stipulate a limited set of conditions that can be evaluated on the fly (“share starting 2 hours prior to the meeting and ending 24 hours after the meeting.”). Contextual leases are role-based, time-based, situational-based, etc. Conditions are contexts set up in the graph.

For example, a context may be a lease context. The lease context specifies usage conditions of one or more resources associated with the lease context that limit usage and/or access to the associated resource(s). A lease context may be activated when an issuing resource (e.g., a document owner) is accepted by a lessee (e.g., an end user account).

The graph model that can be extended by a customer's IT group or a third party ISV. The graph extensions may be used by applications to extend the base data model with additional resource types. Graph extensions can also “specialize” objects, for instance, if a given company wishes to track additional metadata about documents that are not provided in the base document class. New graph objects can be subjected to the same security policy framework, and custom objects are mirrored between domains in the same manner as the built-in objects.

Activity Logging and Correlation to a given Task

A monitoring daemon may run on a computer and monitor the applications launched, files opened, URLs browsed, etc. The purpose of the monitoring daemon is that people frequently consult other sources of information while writing a document, and tracking those behaviors will provide additional metadata that is relevant to the document itself. This may be implemented into an automated assistant that helps you, for example, generate the list of citations or references for a report or paper that a user is researching and/or maintain links to those references as explicit metadata in the contextual graph. The system may accumulate the references or links that a group of people reference while working collaboratively on a document.

### Network Environment

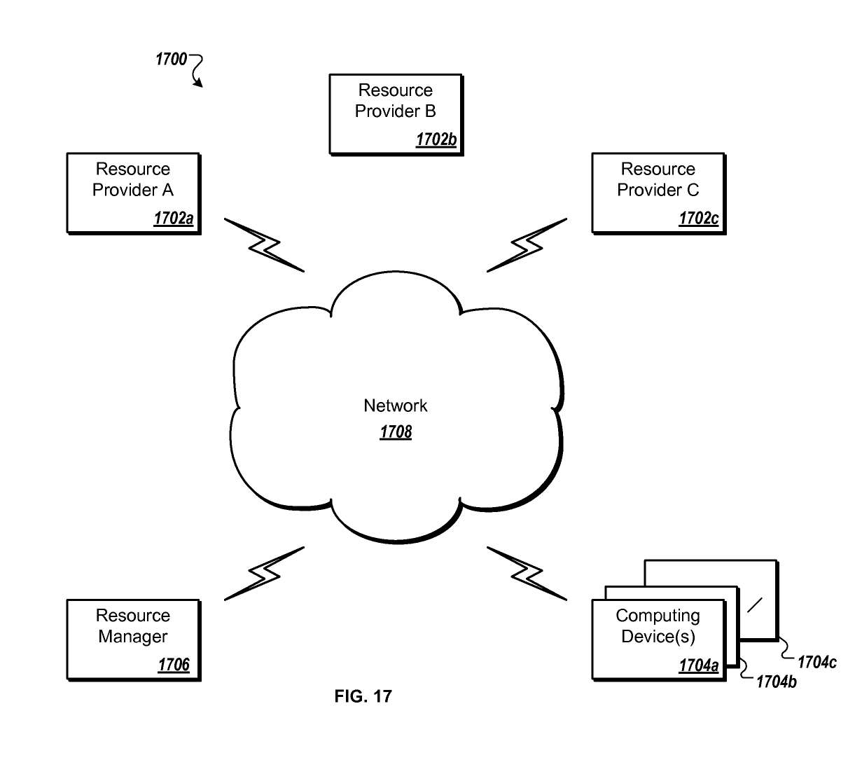

As shown in FIG. 17, an implementation of a network environment 1700 for use a in system implementing a business workflow model is shown and described. In brief overview, referring now to FIG. 17, a block diagram of an exemplary cloud computing environment 1700 is shown and described. The cloud computing environment 1700 may include one or more resource providers 1702a, 1702b, 1702c (collectively, 1702). Each resource provider 1702 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1702 may be connected to any other resource provider 1702 in the cloud computing environment 1700. In some implementations, the resource provider(s) 1702 may be connected over a computer network 1708. Each resource provider 1702 may be connected to one or more computing device 1704a, 1704b, 1704c (collectively, 1704), over the computer network 1708.

The cloud computing environment 1700 may include a resource manager 1706. The resource manager 1706 may be connected to the resource providers 1702 and the computing devices 1704 over the computer network 1708. In some implementations, the resource manager 1706 may facilitate the provision of computing resources by one or more resource providers 1702 to one or more computing devices 1704. The resource manager 1706 may receive a request for a computing resource from a particular computing device 1704. The resource manager 1706 may identify one or more resource providers 1702 capable of providing the computing resource requested by the computing device 1704. The resource manager 1706 may select a resource provider 1702 to provide the computing resource. The resource manager 1706 may facilitate a connection between the resource provider 1702 and a particular computing device 1704. In some implementations, the resource manager 1706 may establish a connection between a particular resource provider 1702 and a particular computing device 1704. In some implementations, the resource manager 1706 may redirect a particular computing device 1704 to a particular resource provider 1702 with the requested computing resource.

### Computing Devices

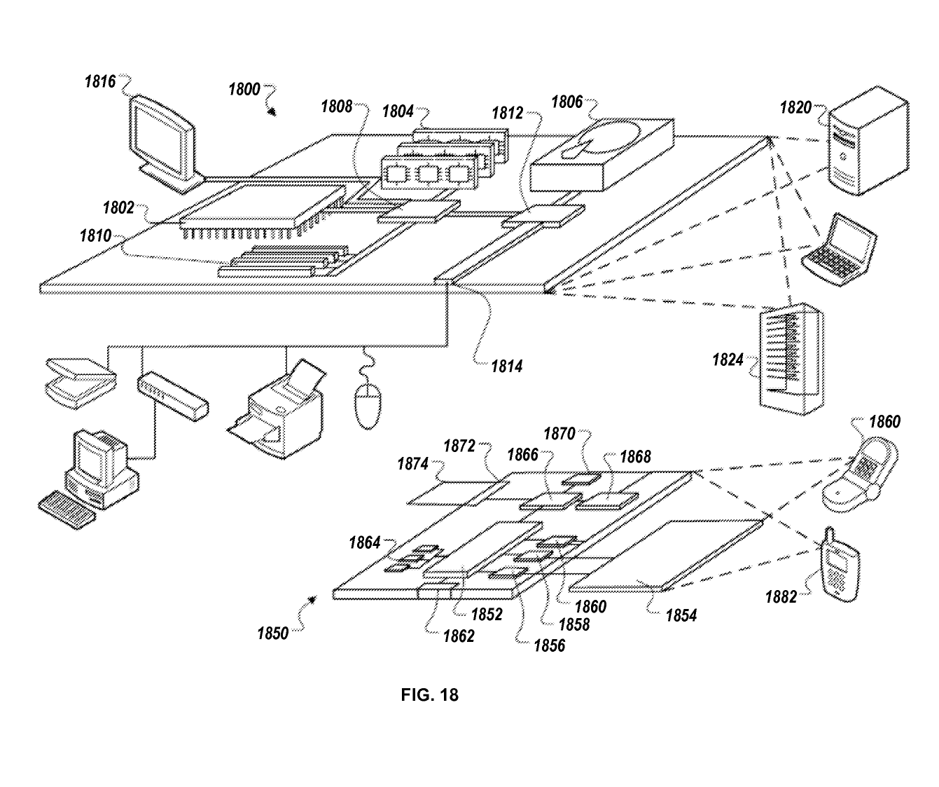

FIG. 18 shows an example of a computing device 1800 and a mobile computing device 1850 that can be used to implement the techniques described in this disclosure. The computing device 1800 is intended to represent various forms of digital computers, such as laptops, desktops, workstations, personal digital assistants, servers, blade servers, mainframes, and other appropriate computers. The mobile computing device 1850 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and may be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1804 stores information within the computing device 1800. In some implementations, the memory 1804 is a volatile memory unit or units. In some implementations, the memory 1804 is a non-volatile memory unit or units. The memory 1804 may also be another form of computer-readable medium, such as a magnetic or optical disk.

The storage device 1806 is capable of providing mass storage for the computing device 1800. In some implementations, the storage device 1806 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1802), perform one or more methods, such as those described above. The instructions can also be stored by one or more storage devices such as computer- or machine-readable mediums (for example, the memory 1804, the storage device 1806, or memory on the processor 1802).

The high-speed interface 1808 manages bandwidth-intensive operations for the computing device 1800, while the low-speed interface 1812 manages lower bandwidth-intensive operations. Such allocation of functions is an example only. In some implementations, the high-speed interface 1808 is coupled to the memory 1804, the display 1816 (e.g., through a graphics processor or accelerator), and to the high-speed expansion ports 1810, which may accept various expansion cards (not shown). In the implementation, the low-speed interface 1812 is coupled to the storage device 1806 and the low-speed expansion port 1814. The low-speed expansion port 1814, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1800 may be implemented in a number of different forms, as shown in the figure. For example, it may be implemented as a standard server 1820, or multiple times in a group of such servers. In addition, it may be implemented in a personal computer such as a laptop computer 1822. It may also be implemented as part of a rack server system 1824. Alternatively, components from the computing device 1800 may be combined with other components in a mobile device (not shown), such as a mobile computing device 1850. Each of such devices may contain one or more of the computing device 1800 and the mobile computing device 1850, and an entire system may be made up of multiple computing devices communicating with each other.

The mobile computing device 1850 includes a processor 1852, a memory 1864, an input/output device such as a display 1854, a communication interface 1866, and a transceiver 1868, among other components. The mobile computing device 1850 may also be provided with a storage device, such as a micro-drive or other device, to provide additional storage. Each of the processor 1852, the memory 1864, the display 1854, the communication interface 1866, and the transceiver 1868, are interconnected using various buses, and several of the components may be mounted on a common motherboard or in other manners as appropriate.

The processor 1852 can execute instructions within the mobile computing device 1850, including instructions stored in the memory 1864. The processor 1852 may be implemented as a chipset of chips that include separate and multiple analog and digital processors. The processor 1852 may provide, for example, for coordination of the other components of the mobile computing device 1850, such as control of user interfaces, applications run by the mobile computing device 1850, and wireless communication by the mobile computing device 1850.

The processor 1852 may communicate with a user through a control interface 1858 and a display interface 1856 coupled to the display 1854. The display 1854 may be, for example, a TFT (Thin-Film-Transistor Liquid Crystal Display) display or an OLED (Organic Light Emitting Diode) display, or other appropriate display technology. The display interface 1856 may comprise appropriate circuitry for driving the display 1854 to present graphical and other information to a user. The control interface 1858 may receive commands from a user and convert them for submission to the processor 1852. In addition, an external interface 1862 may provide communication with the processor 1852, so as to enable near area communication of the mobile computing device 1850 with other devices. The external interface 1862 may provide, for example, for wired communication in some implementations, or for wireless communication in other implementations, and multiple interfaces may also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 may also be provided and connected to the mobile computing device 1850 through an expansion interface 1872, which may include, for example, a SIMM (Single In Line Memory Module) card interface. The expansion memory 1874 may provide extra storage space for the mobile computing device 1850, or may also store applications or other information for the mobile computing device 1850. Specifically, the expansion memory 1874 may include instructions to carry out or supplement the processes described above, and may include secure information also. Thus, for example, the expansion memory 1874 may be provided as a security module for the mobile computing device 1850, and may be programmed with instructions that permit secure use of the mobile computing device 1850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1852), perform one or more methods, such as those described above. The instructions can also be stored by one or more storage devices, such as one or more computer- or machine-readable mediums (for example, the memory 1864, the expansion memory 1874, or memory on the processor 1852). In some implementations, the instructions can be received in a propagated signal, for example, over the transceiver 1868 or the external interface 1862.

The mobile computing device 1850 may communicate wirelessly through the communication interface 1866, which may include digital signal processing circuitry where necessary. The communication interface 1866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA1800, or GPRS (General Packet Radio Service), among others. Such communication may occur, for example, through the transceiver 1868 using a radio-frequency. In addition, short-range communication may occur, such as using a Bluetooth®, Wi-Fi™, or other such transceiver (not shown). In addition, a GPS (Global Positioning System) receiver module 1870 may provide additional navigation- and location-related wireless data to the mobile computing device 1850, which may be used as appropriate by applications running on the mobile computing device 1850.

The mobile computing device 1850 may also communicate audibly using an audio codec 1860, which may receive spoken information from a user and convert it to usable digital information. The audio codec 1860 may likewise generate audible sound for a user, such as through a speaker, e.g., in a handset of the mobile computing device 1850. Such sound may include sound from voice telephone calls, may include recorded sound (e.g., voice messages, music files, etc.) and may also include sound generated by applications operating on the mobile computing device 1850.

The mobile computing device 1850 may be implemented in a number of different forms, as shown in the figure. For example, it may be implemented as a cellular telephone 1880. It may also be implemented as part of a smart-phone 1882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for creating and updating a business workflow model (contextual graph) for an enterprise are provided. Having described certain implementations of methods and apparatus for supporting a business workflow model, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously. Similarly, one or more modules may be combined into a single module and a single module as described may be separated into multiple modules. Moreover, it should be understood that the systems and methods implemented by a processor. When multiple processors are used, the processors may be located remotely from each other and communicate over a network.

Having described various embodiments of the disclose technology, it will now become apparent to one of skill in the art that other embodiments incorporating the concepts may be used. It is felt, therefore, that these embodiments should not be limited to the disclosed embodiments, but rather should be limited only by the spirit and scope of the following claims. Headers are provided for context and are not intended to be limiting.

1-38. (canceled)

39. A method for creating and updating a business workflow model for an enterprise, the method comprising:
creating, by a processor of a computing device, for each of a plurality of users associated with the enterprise, a context list specific to the user, wherein creating the context lists comprises:
for each of a plurality of contexts:
assigning to the context a set of resources associated with the context;
determining a set of users associated with the context to whom a graphical representation of the context will be made visually available;
transmitting, via a network, for each of the plurality of users, data representing content of a newly created or updated context list corresponding to the user;
graphically rendering, on a display of a registered user's computing device, the newly created or updated context list associated with the user following authentication of the user by the processor, wherein the context list is graphically rendered such that contexts populating the context list are positioned on the display in an order;
for each of the contexts, updating, by the processor, the set of resources associated with the context following a change in the set resources associated with the context;
for each of the context lists, updating the context list by adding new contexts associated with the user or previously-created contexts that are newly associated with the user, and graphically rendering, on the display of the corresponding registered user's computing device, the updated context list; and
creating, by a processor of a computing device, upon input by a user, a new context by:
assigning to the new context a set of resources associated with the context;
determining a set of users associated with the new context to whom a graphical representation of the context will be made visually available; and
changing, by a processor of a computing device, upon input by a user, one or more of:
the set of resources associated with a given context; and
the set of users associated with the given context.

40. The method of claim 39, wherein the step of creating the context lists comprises:
for each of a plurality of contexts determining a time associated with the context.

41. The method of claim 39, wherein the context list is graphically rendered on a timeline such that the order reflects a time associated with each context.

42. The method of claim 39, wherein, for each of the context lists, updating the context list comprises eliminating any expired contexts.

43. The method of claim 39, wherein the plurality of contexts comprises one or more projects, meetings, conferences, events, collaborations, ventures, tasks, and/or research endeavors.

44. The method of claim 39, wherein the set of resources associated with a given context comprises one or more persons, documents, locations, devices, assignments, printers, presentation hardware, computers, display monitors, tasks, calendars, documents, multimedia files, graphics, and audio files.

45. The method of claim 39, wherein the method comprises capturing and/or managing metadata associated with one or more of the resources associated with a given context.

46. The method of claim 39, wherein at least one of the plurality of contexts is an event and the method comprises assigning to the event a set of resources associated with the event, wherein the set of resources comprises a plurality of persons and/or documents relevant to the event.

47. The method of claim 46, wherein the set of resources comprises one or more logistical resources, e.g., a meeting room, a start and/or end time, an electronic calendar entry, a remote connection to the event, an access password or access channel to the event, and/or hardware that are available for the event.

48. The method of claim 46, comprising assigning to the event context a logistics context with its own associated set of resources, e.g., a meeting room, a start and/or end time, an electronic calendar entry, a remote connection to the event, an access password or access channel to the event, and/or hardware that are available for the event.

49. The method of claim 39, wherein each resource and/or each context has at least one owner, wherein each owner is a registered user and the resource is associated, in the business workflow model, with the at least one owner.

50. The method of claim 49, wherein the method comprises authenticating, by the processor, that the user is either an owner or a designee of the owner who is authorized to make the change.

51. The method claim 39, wherein at least one of the plurality of contexts is a meeting or a conference.

52. The method of claim 51, wherein a context that is a meeting or conference has a set of resources associated with it, wherein the set of resources comprises one or more of: a set of invitees or participants, documents to be presented at the meeting, documents relevant to the meeting, a meeting room and/or location, hardware devices to be used at the meeting, support staff available for the meeting.

53. The method of claim 52, wherein the set of resources comprises one or more documents to be presented at the meeting.

54. The method of claim 52, wherein the method comprises authorizing to the invitees, by the processor, access to the documents to be presented at the meeting, where the invitees comprise authenticated users and/or guests of authenticated users.

55. The method of claim 52, wherein the at least one resource is remotely accessible by the invitees via one or more computing devices.

56. A system comprising:
a processor; and
a memory having instructions stored thereon, wherein the instructions, when executed by the processor, cause the processor to:
create for each of a plurality of users associated with the enterprise, a context list specific to the user, wherein the processor creates the context lists by, for each of a plurality of contexts, (i) assigning to the context a set of resources associated with the context and (ii) determining a set of users associated with the context to whom a graphical representation of the context will be made visually available;
for each of the plurality of users, cause transmission, via a network, of data representing content of a newly created or updated context list corresponding to the user;
cause graphical rendering, on a display of a registered user's computing device, of the newly created or updated context list associated with the user following authentication of the user by the processor, wherein the context list is graphically rendered such that contexts populating the context list are positioned on the display in an order;
update, for each of the contexts, the set of resources associated with the context following a change in the set resources associated with the context;
update, for each of the context lists, the context list by adding new contexts associated with the user or previously-created contexts that are newly associated with the user, and graphically rendering, on the display of the corresponding registered user's computing device, the updated context list; and
create, upon input by a user, a new context by (i) assigning to the new context a set of resources associated with the context, (ii) determining a set of users associated with the new context to whom a graphical representation of the context will be made visually available, and (iii) changing, upon input by a user, one or more of:
(a) the set of resources associated with a given context, and
(b) the set of users associated with the given context.

57. A non-transitory computer readable medium having instructions stored thereon, wherein the instructions, when executed by a processor, cause the processor to:
create for each of a plurality of users associated with the enterprise, a context list specific to the user, wherein the processor creates the context lists by, for each of a plurality of contexts, (i) assigning to the context a set of resources associated with the context and (ii) determining a set of users associated with the context to whom a graphical representation of the context will be made visually available;
for each of the plurality of users, cause transmission, via a network, of data representing content of a newly created or updated context list corresponding to the user;
cause graphical rendering, on a display of a registered user's computing device, of the newly created or updated context list associated with the user following authentication of the user by the processor, wherein the context list is graphically rendered such that contexts populating the context list are positioned on the display in an order;
update, for each of the contexts, the set of resources associated with the context following a change in the set resources associated with the context;
update, for each of the context lists, the context list by adding new contexts associated with the user or previously-created contexts that are newly associated with the user, and graphically rendering, on the display of the corresponding registered user's computing device, the updated context list; and
create, upon input by a user, a new context by (i) assigning to the new context a set of resources associated with the context, (ii) determining a set of users associated with the new context to whom a graphical representation of the context will be made visually available, and (iii) changing, upon input by a user, one or more of:
(a) the set of resources associated with a given context, and
(b) the set of users associated with the given context.
